(19) United States
(12) Patent Application Publication
(10) Pub. No.: US 2026/0282023 A1
(43) Pub. Date: Sep. 17, 2026

(54) REPORTING DATA VOLUME ASSOCIATED WITH SMALL DATA TRANSMISSION THRESHOLD

(71) Applicant: Telefonaktiebolaget LM Ericsson (publ), Stockholm (SE)

(72) Inventors: Johan RUNE, Lidingö (SE); Ali PARICHEHREHTEROUJENI, Linköping (SE); Angelo CENTONZA, Granada (ES); Luca LUNARDI, Genova (IT); Marco BELLESCHI, Solna (SE)

(21) Appl. No.: 19/471,864

(22) PCT Filed: Apr. 5, 2024
(86) PCT No.: PCT/IB2024/053366

§ 371 Date: Oct. 2, 2025

Related U.S. Application Data
(60) Provisional application No. 63/494,698, filed on Apr. 6, 2023.

(51) Int. Cl. H04W 72/21; H04W 72/02; H04W 74/00; H04W 76/19; H04W 76/27

(52) U.S. Cl. CPC H04W 72/21; H04W 72/02; H04W 74/002; H04W 76/19; H04W 76/27

(57) ABSTRACT

A method, network node and wireless device (WD) for reporting data volume close to small data transmission (SDT) threshold are disclosed. A method in a network node configured to communicate with a user equipment (UE) is described. The method includes receiving small data transmission (SDT) feedback information from the UE, where the SDT feedback information is based at least in part on a volume of data (V) pending for uplink (UL) transmission and an SDT data volume threshold, and performing one or more actions based at least in part on the SDT feedback information.

### TECHNICAL FIELD

The present disclosure relates to wireless communications, and in particular, to reporting data volume close to a small data transmission (SDT) threshold.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes (NNs), such as base stations, and a user equipments (UEs), as well as communication between network nodes and between UEs. The 3GPP is also developing standards for Sixth Generation (6G) wireless communication networks.

### Overall NG-RAN Architecture

The overall architecture of the new generation radio access network (NG-RAN) is described in 3GPP Technical Standard (TS) 38.401 version 17.3.0 (2022-12), and depicted in the example of FIG. 1. The NG-RAN architecture may be further described as follows. The NG-RAN includes a set of gNodeBs (gNBs) connected to the 5G core (5GC) through the NG interface. A network node may support frequency division duplex (FDD) and time division duplex (TDD) or dual mode operation. Network nodes may be interconnected through the Xn interface. A network node may include a gNB centralized unit (gNB-CU) and gNB distributed units (gNB-DUs). A gNB-CU and a gNB-DU are connected via the F1 logical interface. The NG-RAN is layered into a Radio Network Layer (RNL) and a Transport Network Layer (TNL). The NG-RAN architecture, i.e., the NG-RAN logical nodes and interfaces between them, is defined as part of the RNL. The TNL provides services for user plane transport and signaling transport.

A network node may also be connected to an LTE evolved NodeB (eNB) via the X2 interface. Another architectural option is that where an LTE eNB connected to the Evolved Packet Core (EPC) network is connected over the X2 interface with a so called nr-gNB. The latter is a network node not connected directly to a core network (CN) and connected via X2 to an eNB for the sole purpose of performing dual connectivity.

The architecture in FIG. 1 above may be expanded by splitting the gNB-CU into two entities: One gNB-CU user plane (gNB-CU-UP), which serves the user plane and hosts the PDCP protocol and one gNB-CU control plane (gNB-CU-CP), which serves the control plane. A gNB-CU-CP and a gNB-CU-UP communicate over the E1 interface. A network node may include a gNB-CU and one or more gNB-DU(s). A gNB-CU and a gNB-DU is connected via F1 interface. One gNB-DU is connected to only one gNB-CU.

For NG-RAN, the NG and Xn-C interfaces for a network node consisting of a gNB-CU and gNB-DUs, terminate in the gNB-CU. For EN-DC, the S1-U and X2-C interfaces for a network node consisting of a gNB-CU and gNB-DUs, terminate in the gNB-CU.

The overall architecture for separation of gNB-CU-CP and gNB-CU-UP is depicted in FIG. 2. The gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface. One gNB-DU is connected to only one gNB-CU-CP, and one gNB-CU-UP is connected to only one gNB-CU-CP.

### Random Access Channel (RACH) Configuration in NR

A random access process may be a four-step RA (i.e., Type-1 RA) or a two-step RA (i.e., Type-2 RA), both of which are illustrated in FIGS. 3 and 4. System information block 1 (SIB1), which is part of the system information broadcast in a cell includes configuration parameters that informs the UE about relevant aspects of the RA related resources and the UE's expected behavior in the context of random access procedures. The RA related configuration may include PRACH occasion configuration in the time domain and the frequency domain, Msg1/MsgA subcarrier spacing, RA preamble range, synchronization signal block (SSB) to RACH occasion and preamble set mapping, optional RA preamble partitioning information, various parameters related to the UE's behavior during the random access procedure, physical uplink shared channel (PUSCH) configuration for the PUSCH part of MsgA in two-step RA.

Some information elements (IEs) are relevant for the NR RACH configuration such as RACH-ConfigGeneric, RACH-ConfigCommon, RACH-ConfigGenericTwoStep-r16 and RACH-ConfigCommonTwoStep-r16. The two former configure the four-step RA aspects, while the two latter configure two-step RA aspects.

### The Four-Step RA Procedure in NR

A four-step approach is used for the basic random access procedure in NR, as illustrated in FIG. 5. In this approach, the UE detects a synchronization signal (SS) and decodes the broadcasted system information (in particular SIB1 where the RACH configuration is found), followed by transmitting a PRACH preamble (message 1) in the uplink. The network node replies with a random access response (RAR), i.e., message 2, which includes information for the UE's transmission of message 3 (Msg3). Using the information received in the RAR, the UE then transmits a UE identification (message 3) on the PUSCH. In case the UE is in radio resource control idle state (RRC_IDLE state), message 3 includes an RRCSetupRequest message. If the UE is in RRC_INACTIVE state, message 3 includes an RRCResumeRequest or RRCResumeRequest1 message. As the fourth step, the network node then sends a message 4 (Msg4) including a mirrored UE contention resolution “identity”. If the UE is in RRC_IDLE state, message 4 also contains an RRCSetup message (or an RRCReject message). If the UE is in RRC_INACTIVE state, message 4 also includes an RRCResume message (or an RRCSetup message or an RRCReject message). The UE transmits PUSCH (message 3) after receiving a timing advance command in the RAR, allowing PUSCH to be received with a timing accuracy within the cyclic prefix.

### NR PRACH Configuration

In NR, the time and frequency resource on which a PRACH preamble is transmitted is defined as a physical RACH (PRACH) occasion. A PRACH occasion is also called a RACH occasion, or RA occasion (RO). The RO used for the transmission of the preambles in two-step RA is called two-step RO, while the RO used for the transmission of the preambles in four-step RA is called four-step RO. The time resources and preamble format for PRACH transmission is configured by a PRACH configuration index, which indicates a row in a PRACH configuration table. In the frequency domain, NR supports multiple frequency-multiplexed PRACH occasions on the same time-domain PRACH occasion. This is mainly motivated by the support of analog beam sweeping in NR such that the PRACH occasions associated to one SSB are configured at the same time instance but different frequency locations.

Further, in NR there are up to 64 sequences that may be used as random access preambles per PRACH occasion in each cell. The RRC parameter totalNumberOfRA-Preambles determines how many of these 64 sequences are used as random-access preambles per PRACH occasion in each cell. Association between SSB(s) and PRACH occasion(s) for four-step RA in NR

NR supports one-to-one, one-to-many, and many-to-one association between SSB and PRACH occasions, as illustrated in FIGS. 6 and 7. When the UE detects one best SSB beam, a preamble in the set of one or more preambles mapped to this SSB may be selected for the random access, then when the network node detects the preamble, the best SSB beam for this UE is known indirectly so that best beams may be used for transmitting signals to or receiving signals from this UE.

For four-step RA, the preambles associated with each SSB are configured by the two RRC parameters in the RACH-ConfigCommon: ssb-perRACH-OccasionAndCB-PreamblesPerSSB and totalNumberOfRA-Preambles.

For each SSB, the associated preambles per PRACH occasion are further divided into two sets for contention based random access (CBRA) and contention free random access (CFRA). The number of CB preambles per SSB per PRACH occasion is signaled by the RRC parameter #CB-preambles-per-SSB. Preamble indices for CBRA and CFRA are mapped consecutively for one SSB in one PRACH occasion, as shown in FIGS. 8-10

### The Two-Step RA Procedure in NR

The two-step RA procedure (a.k.a. Type-2 RA procedure) was designed to reduce the access delay incurred by the random access procedure. With the two-step RA procedure, the RA procedure is completed in two steps, as illustrated in FIG. 11. UE sends a message A (abbreviated “MsgA” or “msgA”—these two abbreviations are used interchangeably in this disclosure) including a random access preamble on the PRACH together with a PUSCH transmission carrying higher layer data such as an RRCSetupRequest message, possibly with some small additional multiplexed payload. The network node responds with a message B (abbreviated “MsgB” or “msgB”—these two abbreviations are used interchangeably in this disclosure), which in the successful case contains a successRAR MAC subPDU. If the UE is in RRC_IDLE state, Message B may also contain an RRCSetup message (or an RRCReject message). If the UE is in RRC_INACTIVE state, message B may also contain an RRCResume message (or an RRCSetup message, an RRCRelease message or an RRCReject message). Alternatively, the RRCSetup, RRCResume, RRCRelease or RRCReject message may be sent in a subsequent message after message B.

### MsgA Preamble Configuration

The RACH occasions (ROs) for two-step RA may be either separately or are shared with four-step RA. If shared RACH occasions are configured, the two RA types are assigned disjoint sets of preamble indexes, thereby allowing the network node to determine, based on a received preamble, which type of RA procedure the preamble pertains to.

For two-step random access using RACH occasions shared with four-step RA, the configuration provided to a UE indicates a number N of SS/PBCH blocks associated with one PRACH occasion by ssb-perRACH-OccasionAndCB-PreamblesPerSSB and a number Q of contention based preambles per SS/PBCH block per valid PRACH occasion by MsgA-CB-PreamblesPerSSB. The PRACH transmission may be on a subset of PRACH occasions associated with a same SS/PBCH block index for a UE provided with a PRACH mask index by MsgA-ssb-sharedRO-MaskIndex. An example of the SS/PBCH block to RO mapping and the preamble allocation is provided in FIG. 12. Note that only one preamble group is assumed in this example. (Note that “SS/PBCH block” and “SSB” are interchangeable terms.)

For two-step random access using separate RACH occasions, the configuration provided to a UE indicates N of SS/PBCH blocks associated with one PRACH occasion and a number R of contention based preambles per SS/PBCH block per valid PRACH occasion by ssb-perRACH-OccasionAndCB-PreamblesPerSSB-MsgA when provided; otherwise, by ssb-perRACH-OccasionAndCB-PreamblesPerSSB. Since separate ROs are used, the SSB to RO mapping and the preamble allocation are configured independently from the corresponding configuration for four-step RA, and the same configuration principles are used as described above for four-step RA.

### MsgA PUSCH Configuration

A PUSCH occasion (PO) is defined as the time-frequency resource used for one PUSCH transmission. For one MsgA PUSCH occasion, one or more demodulation reference signal (DMRS) resources may be configured, one of which may be selected for each PUSCH transmission within the PUSCH occasion. The term PUSCH resource unit (PRU) is used in this disclosure to define a PUSCH occasion with one DMRS resource. A set of PUSCH occasions are configured per MsgA PUSCH configuration which are relative to and mapped by a group of RA preambles in a set of ROs in one PRACH slot.

### Further Preamble Range Division

Depending on what is configured for a cell, the preamble range may be further divided into subranges. Preamble range partitions (also referred to as preamble partitions) may be configured for:
Four-step RA and two-step RA (in RACH occasions which are shared between two-step RA and four-step RA.
Preamble group A and preamble group B, which are used for coarse indication of the size of the pending uplink (UL) data in the UE to guide the network node in its choice of the size of the UL grant to include in the Random Access Response message (Msg2). If preamble group B is configured, a UE selects a preamble from preamble group B if the expected/desired size of Msg3, as determined by the pending UL data plus signaling overhead, is above a threshold (ra-Msg3SizeGroupA) and the pathloss is less than a certain value. Otherwise, the UE selects a preamble from preamble group A.
Association with different feature groups, wherein transmission of a preamble from a preamble partition associated with a certain feature group signals to the network node that the random access concerns a feature in the feature group so that the network node may adapt its behavior, e.g., in terms of responses and interpretation of Msg3, accordingly.

As the association of preamble partitions with different feature groups is of some relevance for the disclosure, it is described in further detail in the following subsection.

### RA Partitioning to Support Feature Signaling

For some features there is a need for the UE to provide an indication to the network already in the first message of the random access procedure, i.e., using the preamble. For example, a UE may need to indicate that the UE is of a certain type or that the UE wants to apply a certain feature. As one example, 3GPP has concluded that a UE of reduced capabilities (sometimes called RedCap UE) may benefit from indicating to the network during the random access procedure that the UE is a RedCap UE rather than a non-RedCap UE. Another example of such a feature is an indication from the UE whether the UE wants to use the Small Data Transmission (SDT) feature.

To provide such an indication during the random access procedure, 3GPP has introduced the possibility to (through configuration) partition a cell's random access preambles so that different partitions may be dedicated to different features, e.g., RedCap UEs, or feature combinations, e.g., RedCap and SDT may share the same preamble partition.

The network (and the UEs) may support several features which require indications during the random access procedure. For example, both support RedCap and SDT. That means that there will be several partitions to indicate combinations of features, e.g.,:
one partition for non-RedCap UEs which do not want to apply SDT,
one partition for non-RedCap UEs which do want to apply SDT,
one partition for RedCap UEs which do not want to apply SDT, and
one partition for RedCap UEs which do want to apply SDT.

A preamble partition may be valid in all RACH occasions or only in a subset of the RACH occasions. That is, in the latter case, one set of preambles is dedicated for one feature (or combination of features), optionally limited to a certain subset of the RACH occasions. Similarly, another set of preambles is dedicated for another feature (or another combination of features), optionally limited to a certain (possibly different) subset of the RACH occasions.

If a UE that intends to initiate a random access procedure needs to (or would benefit from) signal to the network the feature or feature combination that triggered the random access, the UE selects a preamble from the RA preamble partition associated with a feature combination (provided that such RA preamble range partitioning is configured in the cell) including the triggering feature (or triggering feature combination). If a combination of features triggered the random access procedure in the UE, and there is no configured RA partition that is associated with a feature combination that includes all the UE's triggering features, or if the feature or feature combination that triggered the random access procedure in the UE maps to more than one configured RA partition, the UE checks the priorities associated with the triggering features and selects RA preamble partition based on these priorities.

### Small Data Transmission (SDT)

Small Data Transmission (SDT) is a procedure allowing data and/or signaling transmission while remaining in RRC_INACTIVE state (i.e., without transitioning to RRC_CONNECTED state). SDT is enabled on a radio bearer basis and is initiated by the UE only if less than a configured amount of UL data awaits transmission across all radio bearers for which SDT is enabled, the downlink (DL) RSRP is above a configured threshold, and a valid SDT resource is available. The duration of an SDT procedure is limited and controlled by a supervision timer, e.g., T319a.

An SDT procedure may be carried out using an RA procedure (i.e., RA-SDT) or utilizing configured grants (CG-SDT). In the context of RA-SDT, SDT resources refer to a set of RA resources, which, again in the context of RA-SDT, refers to a set of RA preambles (also referred to as a preamble partition i.e., a subrange of the preambles available in the cell). A RA preamble from this set of RA preambles indicates to the receiving network node that the RA procedure concerns SDT. Furthermore, for SDT to be possible, it is also required that at least one data radio bearer (DRB) has been configured to allow SDT. Depending on the definition, this (these) DRB(s) may or may not be seen as part of the SDT resources. The first SDT data is included in Msg3 of the RA procedure. Any subsequent SDT data is handled using dynamic DL assignments and UL grants.

For an SDT procedure over RACH, if the UE accesses a network node other than the last serving network node (also referred to as the anchor network node, i.e., the network node which stores the UE's context in the RAN), the UL SDT data/signaling is buffered at the receiving network node, and then the receiving network node triggers the XnAP Retrieve UE Context procedure. The receiving network node indicates SDT to the last serving network node and the last serving network node decides whether to relocate the UE context or not. Other SDT assistance information (e.g., single packet, multiple packets) may also be provided by the receiving network node to help the decision of UE context relocation.

If the last serving network node decides not to relocate the full UE context, it transfers a partial UE context containing SDT RLC context information necessary for the receiving network node to handle SDT via the Partial UE Context Transfer procedure.

Then, in case SDT is used for user plane data over DRBs, UL/DL tunnels are established for the DRBs configured for SDT. If only a partial UE context was transferred, the UL/DL tunnels are established between the receiving network node and the last serving network node (and the last serving network node handles the data forwarding to/from the user plane function (UPF)). If the full UE context was relocated, the UL tunnel is established from the receiving network node to the UPF while the DL tunnel is established between the last serving network node and the receiving network node, and then a path switch is performed, after which any remaining SDT packets are forwarded through tunnels between the receiving network node and the UPF in both the UL and the DL. The packet data control protocol (PDCP) packet data units (PDU(s)) with UL/DL data is (are) transferred over the tunnels, until the last serving network node detects the end of the SDT session.

After the end of the SDT session, if the UE context was relocated to the receiving network node, the receiving network node directs the UE to continue in RRC_INACTIVE state (or to go to RRC_IDLE state) by sending an RRCRelease message (or to go to RRC_CONNECTED state by sending an RRCResume message).

If only a partial UE context was transferred to the receiving network node, then, after the end of the SDT session, the receiving network node sends a RETRIEVE UE CONTEXT CONFIRM XnAP message to the last serving network node indicating whether this is a “normal” end of SDT transaction or a radio link problem. The last serving network node responds to the receiving network node with the RETRIEVE UE

CONTEXT FAILURE XnAP message including an encapsulated RRCRelease message, which the receiving network node forwards to the UE, and then releases the partial UE context.

In case SDT is used for signaling (i.e., control plane data), signaling radio bearer (SRB) PDCP PDUs are transferred between the receiving network node and the last serving network node via the XnAP RRC Transfer procedure, until the last serving network node terminates the SDT session and directs the UE to continue in RRC_INACTIVE state by sending the RRCRelease message.

A UE is configured for SDT through configuration data in SIB1 and in the RRCRelease message when the UE is released from RRC_CONNECTED to RRC_INACTIVE state.

The configuration of a RA preamble partition for RA-SDT is part of the configuration of RA preambles associated with certain features, which involves associating RA preamble partitions with different feature combinations. This is configured in the FeatureCombinationPreambles-r17 IE in 3GPP TS 38.331 version 17.3.0. The features which may be included in such a feature combination according to release 17 of the 3GPP standard for NR include RedCap, SDT, Network Slice AS Group (NSAG), and RA Msg3 repetition. Hence, the RA preambles for SDT are associated with the feature combination(s) which SDT is included in, which may include only SDT, but which may also include SDT together with one or more of the other above listed features. The optional ssb-SharedRO-MaskIndex-r17 IE may be used to indicate a subset of the RACH occasions in which the preamble partition is allocated to the concerned feature combination.

The configuration of SDT consists of common parts in SIB1 and a UE specific part, which is included in the SDT-Config-r17 IE in the SuspendConfig IE which is included in the RRCRelease message when the UE is released to RRC_INACTIVE state.

A relevant ASN.1 code in SIB1 is included in the field sdt-ConfigCommon-r17, which is an SDT-ConfigCommonSIB-r17 IE, and the FeatureCombinationPreambles-r17 IEs in the featureCombinationPreamblesList-r17 field in the RACH-ConfigCommon IE. The RACH-ConfigCommon IE is in turn included in a BWP-UplinkCommon IE which is included in an UplinkConfigCommonSIB IE which is included in a Serving CellConfigCommonSIB IE in SIB1.

The most relevant ASN.1 code for the UE specific SDT configuration part in the RRCRelease message is included in an SDT-Config-r17 IE in a SuspendConfig IE.

### RA Optimization

RA optimization may be seen as SON functionality. Self-Organizing Network (SON) is an umbrella term for various functionality facilitating a mobile communication network to optimize various aspects of its operation, which typically involves adjustment of various configuration parameters. In the standardization of SON features, 3GPP has the principle to only specify the means by which the network may obtain input data, e.g., feedback data, to base such optimizations on, while the optimizing actions, and the algorithms they are based on, are left to network implementation. To this end, 3GPP has specified various mechanisms by which a network may collect information from UEs in the network, including measurement results, neighbor cell information, and information providing feedback on performed operation.

An RA report was initially specified in 3GPP release 16. In release 17 of the 3GPP standard, more information to include in the RA report was specified, in particular information related to two-step RA and RA-based system information request. In 3GPP release 18, further information to include in the RA report is expected to be specified, including the above mentioned feature combination related information and information related to failed RA-SDT. Another type of information that is discussed for inclusion in the RA report is the result of power measurements for CCA/LBT in conjunction with random access in NR shared (unlicensed) spectrum. Both indication of measured power per RA attempt (as one proposal) and indication of measured power per RA procedure (as another proposal) are being discussed.

### SDT Optimization

As SON feedback information is extended to SDT related information, automatic optimization of SDT configuration parameters is facilitated. Notably, 3GPP has started on this path with the 3GPP agreement quoted above which says that SDT information should be included in the RA report in case of SDT failure.

The SON mechanisms for RA optimization described above include provisioning of feedback information which may be useful for optimization of various aspects of the random access related configuration in a cell. The recent 3GPP agreement regarding inclusion of feature combination indications in the RA report extends these aspects to include also the preamble partitioning and its associations with feature combinations.

This also allows the network to adapt/optimize certain configuration aspects/parameters of the various features that are associated with preamble partitions, e.g., how many preambles each feature should be associated with and/or which features that should share the same preamble partition (i.e., which features that should constitute a feature combination or which features to be grouped together within the same partition).

Another 3GPP agreement quoted above state that SDT information should be included in the RA report in case of SDT failure. However, this agreement is restrictive, because it is restricted to cases where SDT fails, and this also limits the type of feedback information the network may get for optimization of the SDT configuration.

An aspect of one of SDT configuration is the size of the threshold for the volume of data which is waiting to be transmitted and which may trigger the UE to use SDT (if the pending data volume is smaller than or equal to the threshold), i.e., the threshold referred to as sdt-DataVolumeThreshold in 3GPP TS 38.331 version 17.3.0 and 3GPP TS 38.321 version 17.3.0. The 3GPP agreement mentions nothing about including information in the RA report that would guide the network's setting of the SDT data volume threshold.

Furthermore, failing SDT supposedly requires that the UE attempted to use SDT. This is supported by the definition of the T319a SDT failure supervision timer in 3GPP TS 38.331 version 17.3.0, which is specified to be started upon transmission of RRCResumeRequest or RRCResumeRequest1 when the resume procedure is initiated for SDT. A UE will do this only if the pending data volume is smaller than or equal to the SDT data volume threshold sdt-DataVolumeThreshold. Hence, the UE will not include any information in the RA report for the times when the pending data volume was greater than the SDT data volume threshold, and consequently the network will not get any feedback information from those cases, thereby severely limiting the network's potential to make well-founded decisions on adaptations of the size of the SDT data volume threshold (sdt-DataVolumeThreshold).

As an example, the volume of data the UE might need to transmit may often be marginally above the configured sdt-DataVolumeThreshold to the point that its transmission by means of SDT may not require any further changes in network and UE configuration (e.g., changes in the sdt-RSRP-Threshold-r17) nor it would imply an impact on network performance. Yet, an SDT failure will occur in this case and being the network unaware of the reasons of such failure, there is no possibility to optimize the network and UE configuration to tailor SDT to the data volume demand of specific UEs/applications while optimally using system's resources.

### SUMMARY

Some embodiments advantageously provide methods, network nodes and UEs for reporting data volume close to small data transmission (SDT) threshold.

Some embodiments include SDT feedback reporting options which may focus on the pending UL data volume and its relation to the SDT data volume threshold (e.g., mainly targeting optimization of the SDT data volume threshold).

In some embodiments, multiple options for possible SDT feedback information that may be reported (e.g., included in the RA report or in the RA related part of the RLF report or in the RA related part of the connection establishment failure report) from a UE to the network are described.

Some embodiments provide extending SDT feedback reporting to successful SDT procedures and mechanisms and rules for reporting the pending UL data volume and its relation to the SDT data volume threshold, or indicating this relation. Some other embodiments provide various options for SDT feedback information that may be reported from a UE to the network, and rules and conditions for when and what to report, including e.g., the measured RSRP and its relation to the SDT RSRP threshold. In an embodiment, indications indicating the reasons for not using SDT for a UE supporting SDT are provided.

Some embodiments optimize the SDT related configuration based on improved and extended SDT feedback information reported from a UE to the network, thereby enabling better SON mechanisms for SDT configuration optimization. In some embodiments, information provided by the UE, enables the network to keep an optimal amount of the UEs in Inactive/IDLE state (not bringing them to connected state) while allowing the UEs to transmit their small data in a way that reaches an optimal balance between system performance impact (e.g., resources employed for SDT transmission, interference generated on such resources) and minimization of number of UEs moving to RRC connected. More specifically, as SON feedback information is extended to SDT related information, automatic optimization of SDT configuration parameters is facilitated.

In some embodiments, an SDT configuration parameter to optimize is the SDT data volume threshold (e.g., the sdt-Data VolumeThreshold-r17 IE). Some embodiments an SDT configuration parameter to potentially optimize is the SDT RSRP threshold (i.e., the sdt-RSRP-Threshold-r17 IE). In some other embodiments, the RSRP threshold that the measured RSRP must exceed for the UE to be allowed to use the SDT feature.

In some embodiments, the SDT data volume threshold and the SDT RSRP threshold are not independent of each other. The larger the volume of data to be transferred via SDT, e.g., in a RA Msg3, the more robust the coding may be to maintain unchanged error probability, unless the RSRP is increased. Hence, increasing the SDT data volume threshold may often be accompanied by an increased SDT RSRP threshold.

Other SDT related configuration aspects that may be adapted, optimized and facilitated is the grouping of features into feature combinations, i.e., from the SDT perspective, and which features (if any) to combine with SDT into a feature combination associated with a RA preamble partition.

According to one aspect, a method in a network node configured to communicate with a user equipment (UE) is described. The method includes receiving small data transmission (SDT) feedback information from the UE, where the SDT feedback information is based at least in part on a volume of data (V) pending for uplink (UL) transmission and an SDT data volume threshold, and performing one or more actions based at least in part on the SDT feedback information.

In some embodiments, the volume of data (V) represents an amount of UL data awaiting transmission across one or more radio bearers for which SDT is enabled in the UE.

In some other embodiments, one or both of: 1) if the volume of data (V) is equal to or less than the SDT data volume threshold plus a first offset parameter (D), the SDT feedback information includes one or both of: 1a) information associated with the volume of data pending for UL transmission; and 1b) a first indication indicating that the volume of data (V) pending for UL transmission is equal to or less than the SDT data volume threshold plus the first offset parameter (D); and 2) the SDT feedback information includes the first indication indicating that a difference between the size of the volume of data pending for UL transmission and the SDT data volume threshold is a percentage of the SDT data volume threshold.

In some embodiments, the first offset parameter (D) is based on the SDT data volume threshold.

In some other embodiments, one or both of: 1) the SDT data volume threshold is associated with a reference signal received power (RSRP) threshold; and 2) if the UE supports SDT, a measured RSRP is above the RSRP threshold, and SDT is not used, the SDT feedback information includes a second indication indicating whether the volume of data (V) is greater than the SDT data volume threshold plus the first offset parameter (D).

In some embodiments, if the volume of data (V) is greater than or equal to the SDT data volume threshold minus a second offset parameter (D_{low}) and the volume of data (V) is less than or equal to the SDT data volume threshold plus a third offset parameter (D_{high}) one or both of: 1) the SDT feedback information includes information associated with the volume of data pending for UL transmission; and 2) a third indication indicating that the volume of data (V) is greater than or equal to the SDT data volume threshold minus the second offset parameter (D_{low}) and the volume of data (V) is less than or equal to the SDT data volume threshold plus the third offset parameter (D_{high}), where the third offset parameter (D_{high}) is greater than the second offset parameter (D_{low}).

In some other embodiments, the SDT feedback information includes a parameter describing a cause for not using SDT.

In some embodiments, the SDT feedback information includes a fourth indication indicating the volume of data (V) and a first relation to the SDT data volume threshold, and a measured RSRP, and a second relation to an RSRP threshold.

In some other embodiments, the SDT feedback information is comprised in a random access report.

In some embodiments, the SDT feedback information is received from the UE according to one or more of: 1) per each random access procedure; 2) in a random access portion of a radio link failure report or a connection establishment failure report; 3) in an information element associated with a random access information parameter; and 4) per random access attempt.

In some other embodiments, the one or more actions includes adjusting SDT data volume threshold based at least in part on the SDT feedback information, determining an SDT configuration; and transmitting the SDT configuration to the UE.

According to another aspect, a network node configured to communicate with a user equipment (UE) is described. The network node is configured to receive small data transmission (SDT) feedback information from the UE, where the SDT feedback information being based at least in part on a volume of data (V) pending for uplink (UL) transmission and an SDT data volume threshold, and perform one or more actions based at least in part on the SDT feedback information.

In some embodiments, the volume of data (V) represents an amount of UL data awaiting transmission across one or more radio bearers for which SDT is enabled in the UE.

In some other embodiments, one or both of: 1) if the volume of data (V) is equal to or less than the SDT data volume threshold plus a first offset parameter (D) the SDT feedback information includes one or both of: 1a) information associated with the volume of data pending for UL transmission; and 1b) a first indication indicating that the volume of data (V) pending for UL transmission is equal to or less than the SDT data volume threshold plus the first offset parameter (D); and 2) the SDT feedback information includes the first indication indicating that a difference between the size of the volume of data pending for UL transmission and the SDT data volume threshold is a percentage of the SDT data volume threshold.

In some embodiments, the first offset parameter (D) is based on the SDT data volume threshold.

In some other embodiments, one or both of: 1) the SDT data volume threshold is associated with a reference signal received power (RSRP) threshold; and 2) if the UE supports SDT, a measured RSRP is above the RSRP threshold, and SDT is not used, the SDT feedback information includes a second indication indicating whether the volume of data (V) is greater than the SDT data volume threshold plus the first offset parameter (D).

In some embodiments, if the volume of data (V) is greater than or equal to the SDT data volume threshold minus a second offset parameter (D_{low}) and the volume of data (V) is less than or equal to the SDT data volume threshold plus a third offset parameter (D_{high}) one or both of: 1) the SDT feedback information includes information associated with the volume of data pending for UL transmission; and 2) a third indication indicating that the volume of data (V) is greater than or equal to the SDT data volume threshold minus the second offset parameter (D_{low}) and the volume of data (V) is less than or equal to the SDT data volume threshold plus the third offset parameter (D_{high}), where the third offset parameter (D_{high}) is greater than the second offset parameter (D_{low}).

In some other embodiments, the SDT feedback information includes a parameter describing a cause for not using SDT.

In some embodiments, the SDT feedback information includes a fourth indication indicating the volume of data (V) and a first relation to the SDT data volume threshold and a measured RSRP, and a second relation to an RSRP threshold.

In some other embodiments, the SDT feedback information is comprised in a random access report.

In some embodiments, the SDT feedback information is received from the UE according to one or more of: 1) per each random access procedure; 2) in a random access portion of a radio link failure report or a connection establishment failure report; 3) in an information element associated with a random access information parameter; and 4) per random access attempt.

In some other embodiments, the one or more actions includes adjusting SDT data volume threshold based at least in part on the SDT feedback information, determining an SDT configuration and transmitting the SDT configuration to the UE.

According to one aspect, a method in a user equipment (UE) configured to communicate with a network node is described. The method includes determining small data transmission (SDT) feedback information, where the SDT feedback information is based at least in part on a volume of data (V) pending for uplink (UL) transmission and an SDT data volume threshold, and transmitting the SDT feedback information to the network node.

In some embodiments, the volume of data (V) represents an amount of UL data awaiting transmission across one or more radio bearers for which SDT is enabled in the UE.

In some other embodiments, one or both of: 1) if the volume of data (V) is equal to or less than the SDT data volume threshold plus a first offset parameter (D), the SDT feedback information includes one or both of: 1a) information associated with the volume of data pending for UL transmission and 1b) a first indication indicating that the volume of data (V) pending for UL transmission is equal to or less than the SDT data volume threshold plus the first offset parameter (D); and 2) the SDT feedback information includes the first indication indicating that a difference between the size of the volume of data pending for UL transmission and the SDT data volume threshold is a percentage of the SDT data volume threshold.

In some embodiments, the first offset parameter (D) is based on the SDT data volume threshold.

In some other embodiments, one or both of: 1) the SDT data volume threshold is associated with a reference signal received power (RSRP) threshold; and 2) if the UE supports SDT, a measured RSRP is above the RSRP threshold, and SDT is not used, the SDT feedback information includes a second indication indicating whether the volume of data (V) is greater than the SDT data volume threshold plus the first offset parameter (D).

In some embodiments, if the volume of data (V) is greater than or equal to the SDT data volume threshold minus a second offset parameter (D_{low}) and the volume of data (V) is less than or equal to the SDT data volume threshold plus a third offset parameter (D_{high}) one or both of: 1) the SDT feedback information includes information associated with the volume of data pending for UL transmission; and 2) a third indication indicating that the volume of data (V) is greater than or equal to the SDT data volume threshold minus the second offset parameter (D_{low}) and the volume of data (V) is less than or equal to the SDT data volume threshold plus the third offset parameter (D_{high}), where the third offset parameter (D_{high}) is greater than the second offset parameter (D_{low}).

In some other embodiments, the SDT feedback information includes a parameter describing a cause for not using SDT.

In some embodiments, the SDT feedback information includes a fourth indication indicating the volume of data (V) and a first relation to the SDT data volume threshold and a measured RSRP, and a second relation to an RSRP threshold.

In some other embodiments, the SDT feedback information is comprised in a random access report.

In some embodiments, the SDT feedback information is transmitted from the UE according to one or more of: 1) per each random access procedure; 2) in a random access portion of a radio link failure report or a connection establishment failure report; 3) in an information element associated with a random access information parameter; and 4) per random access attempt.

In some other embodiments, one or both of: 1) transmitting the SDT feedback information to the network node triggers the network node to one or both of: 1a) adjust SDT data volume threshold based at least in part on the SDT feedback information; and 1b) determine an SDT configuration; and 2) the method further includes receiving the SDT configuration from the network node.

According to another aspect, a user equipment (UE) configured to communicate with a network node is described. The UE is configured to determine small data transmission (SDT) feedback information, where the SDT feedback information being based at least in part on a volume of data (V) pending for uplink (UL) transmission and an SDT data volume threshold, and transmit the SDT feedback information to the network node.

In some embodiments, the volume of data (V) represents an amount of UL data awaiting transmission across one or more radio bearers for which SDT is enabled in the UE.

In some other embodiments, one or both of: 1a) if the volume of data (V) is equal to or less than the SDT data volume threshold plus a first offset parameter (D) the SDT feedback information includes one or both of: 1a) information associated with the volume of data pending for UL transmission; and 1b) a first indication indicating that the volume of data (V) pending for UL transmission is equal to or less than the SDT data volume threshold plus the first offset parameter (D); and 2) the SDT feedback information includes the first indication indicating that a difference between the size of the volume of data pending for UL transmission and the SDT data volume threshold is a percentage of the SDT data volume threshold.

In some embodiments, the first offset parameter (D) is based on the SDT data volume threshold.

In some other embodiments, one or both of: 1) the SDT data volume threshold is associated with a reference signal received power (RSRP) threshold; and 2) if the UE supports SDT, a measured RSRP is above the RSRP threshold, and SDT is not used, the SDT feedback information includes a second indication indicating whether the volume of data (V) is greater than the SDT data volume threshold plus the first offset parameter (D).

In some embodiments, if the volume of data (V) is greater than or equal to the SDT data volume threshold minus a second offset parameter (D_{low}) and the volume of data (V) is less than or equal to the SDT data volume threshold plus a third offset parameter (D_{high}) one or both of: 1) the SDT feedback information includes information associated with the volume of data pending for UL transmission; and 2) a third indication indicating that the volume of data (V) is greater than or equal to the SDT data volume threshold minus the second offset parameter (D_{low}) and the volume of data (V) is less than or equal to the SDT data volume threshold plus the third offset parameter (D_{high}), where the third offset parameter (D_{high}) is greater than the second offset parameter (D_{low}).

In some other embodiments, the SDT feedback information includes a parameter describing a cause for not using SDT.

In some embodiments, the SDT feedback information includes a fourth indication indicating the volume of data (V) and a first relation to the SDT data volume threshold and a measured RSRP, and a second relation to an RSRP threshold.

In some other embodiments, the SDT feedback information is comprised in a random access report.

In some embodiments, the SDT feedback information is transmitted from the UE according to one or more of: 1) per each random access procedure; 2) in a random access portion of a radio link failure report or a connection establishment failure report; 3) in an information element associated with a random access information parameter; and 4) per random access attempt.

In some other embodiments, one or both of: 1) transmitting the SDT feedback information to the network node triggers the network node to one or both of: 1a) adjust SDT data volume threshold based at least in part on the SDT feedback information; and 1b) determine an SDT configuration; and 2) the UE is further configured to receive the SDT configuration from the network node.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an example of an overall NG-RAN architecture;

FIG. 2 is an example split gNB architecture;

FIG. 3 illustrates an example four-step RA procedure;

FIG. 4 illustrates an example two-step RA procedure;

FIG. 5 illustrates a 4 step RA procedure;

FIG. 6 is a PRACH configuration in NR;

FIG. 7 is an example of an SSB per PRACH occasion;

FIG. 8 is an example with 2 SSBs per PRACH occasion;

FIG. 9 illustrates a mapping between SSB and RA preambles;

FIG. 10 illustrates associated preambles;

FIG. 11 illustrates a 2 step RA procedure;

FIG. 12 illustrates configured preambles;

FIG. 13 is a schematic diagram of an example network architecture illustrating a communication system connected via an intermediate network to a host computer according to the principles in the present disclosure;

FIG. 14 is a block diagram of a host computer communicating via a network node with a UE over an at least partially wireless connection according to some embodiments of the present disclosure;

FIG. 15 is a flowchart illustrating example methods implemented in a communication system including a host computer, a network node and a UE for executing a client application at a UE according to some embodiments of the present disclosure;

FIG. 16 is a flowchart illustrating example methods implemented in a communication system including a host computer, a network node and a UE for receiving user data at a UE according to some embodiments of the present disclosure;

FIG. 17 is a flowchart illustrating example methods implemented in a communication system including a host computer, a network node and a UE for receiving user data from the UE at a host computer according to some embodiments of the present disclosure;

FIG. 18 is a flowchart illustrating example methods implemented in a communication system including a host computer, a network node and a UE for receiving user data at a host computer according to some embodiments of the present disclosure;

FIG. 19 is a flowchart of an example process in a network node for reporting data volume close to small data transmission (SDT) threshold;

FIG. 20 is a flowchart of an example process in a UE for reporting data volume close to small data transmission (SDT) threshold;

FIG. 21 is a flowchart of another example process in a network node for reporting data volume close to small data transmission (SDT) threshold; and

FIG. 22 is a flowchart of another example process in a UE for reporting data volume close to small data transmission (SDT) threshold.

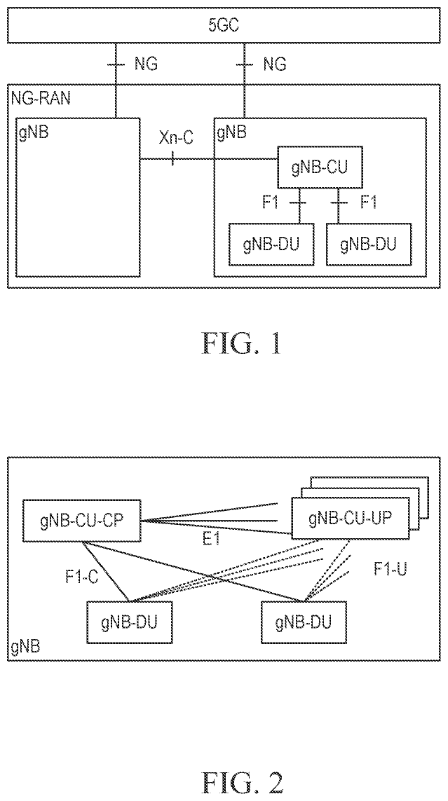

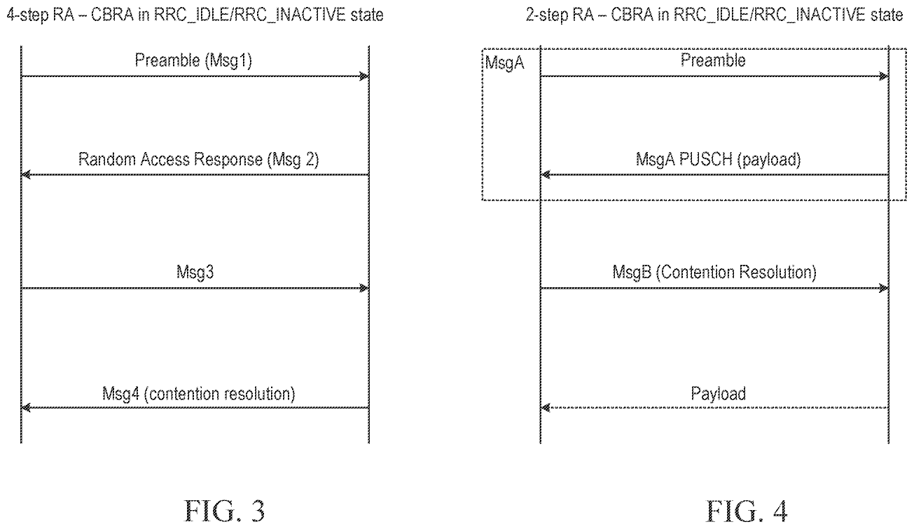

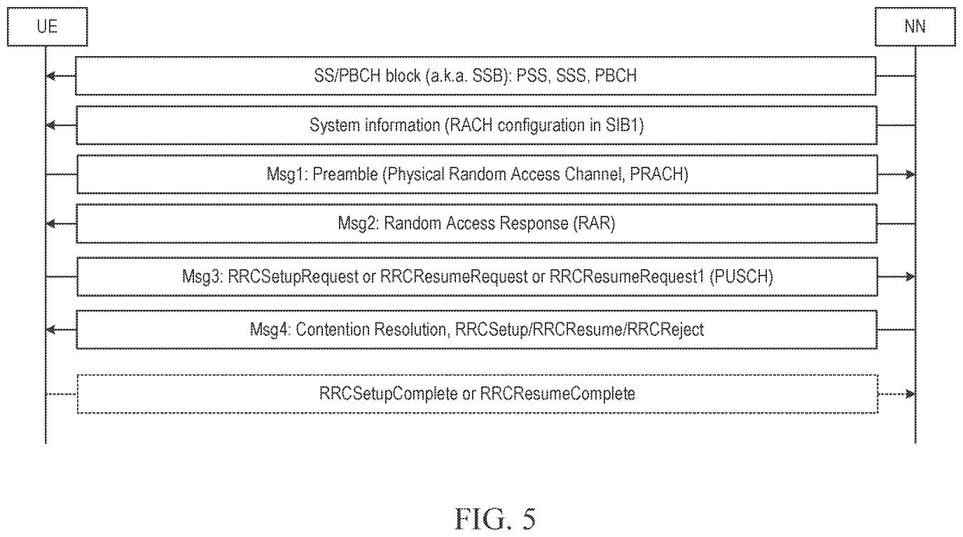

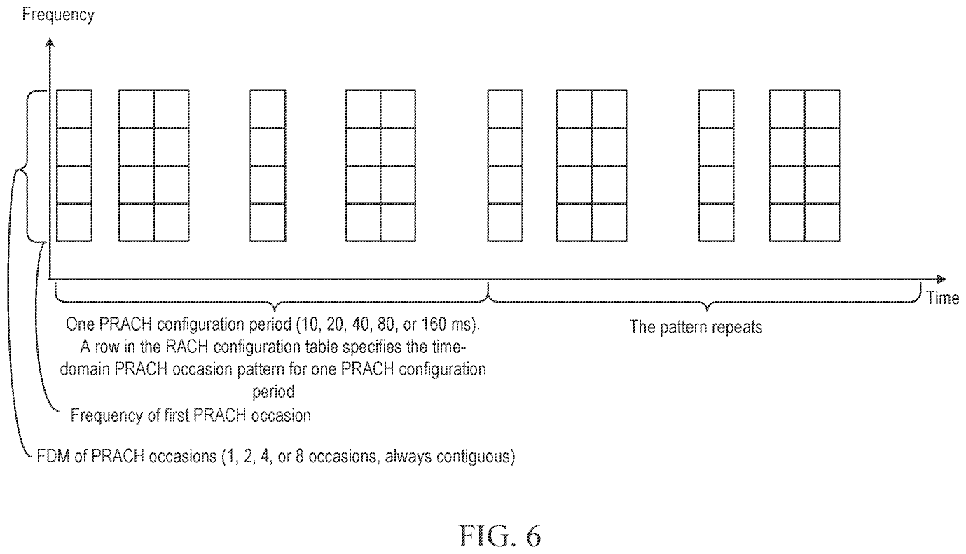

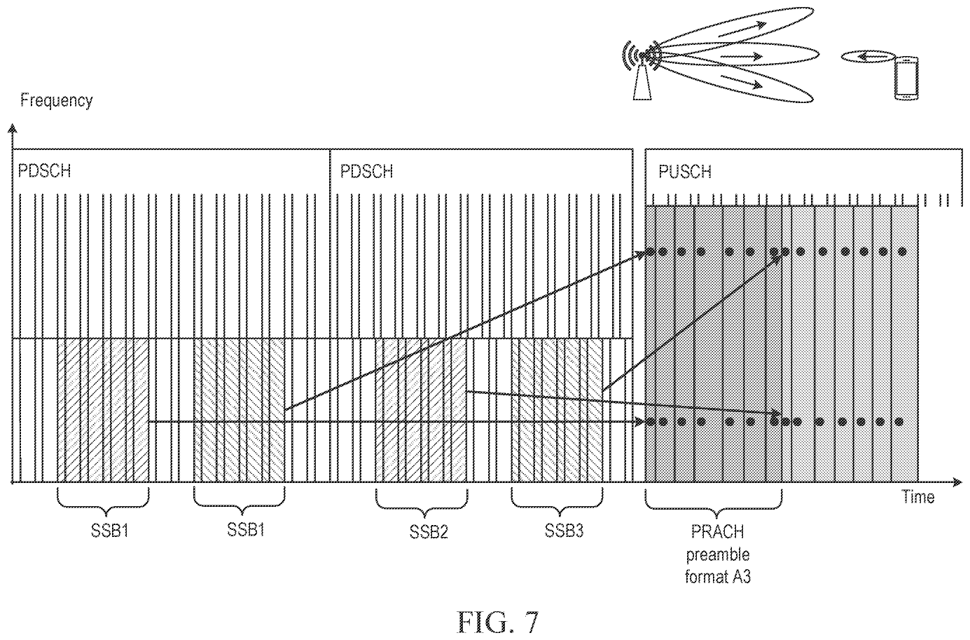

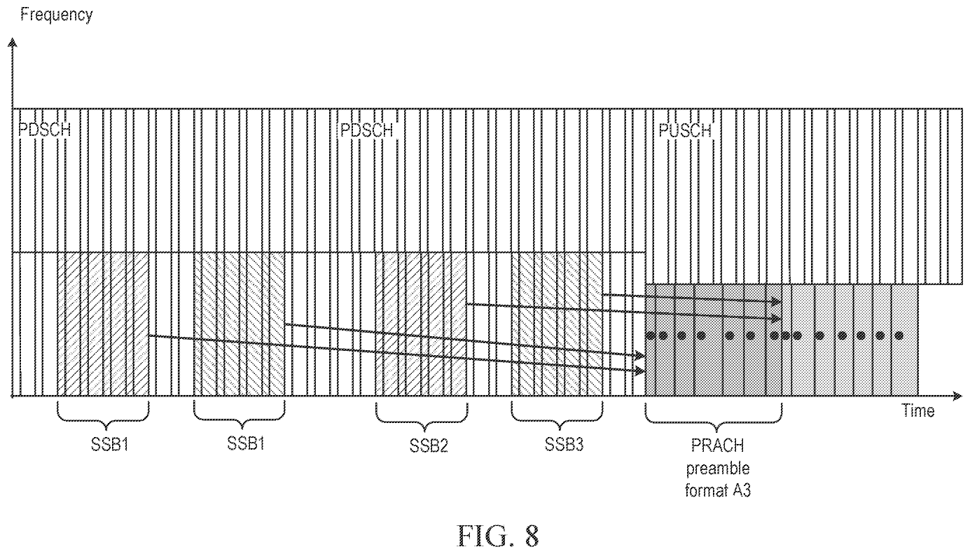

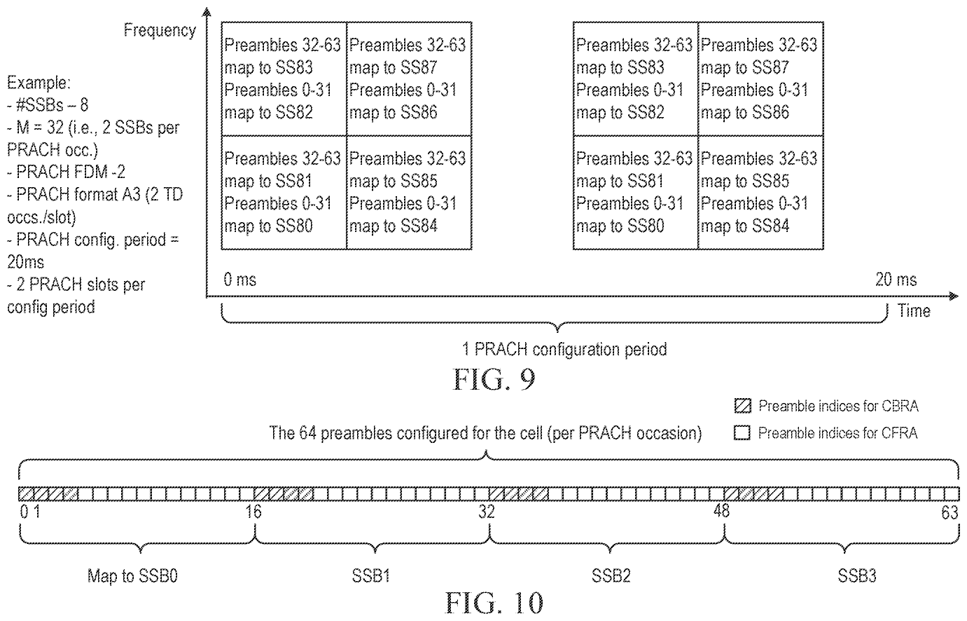

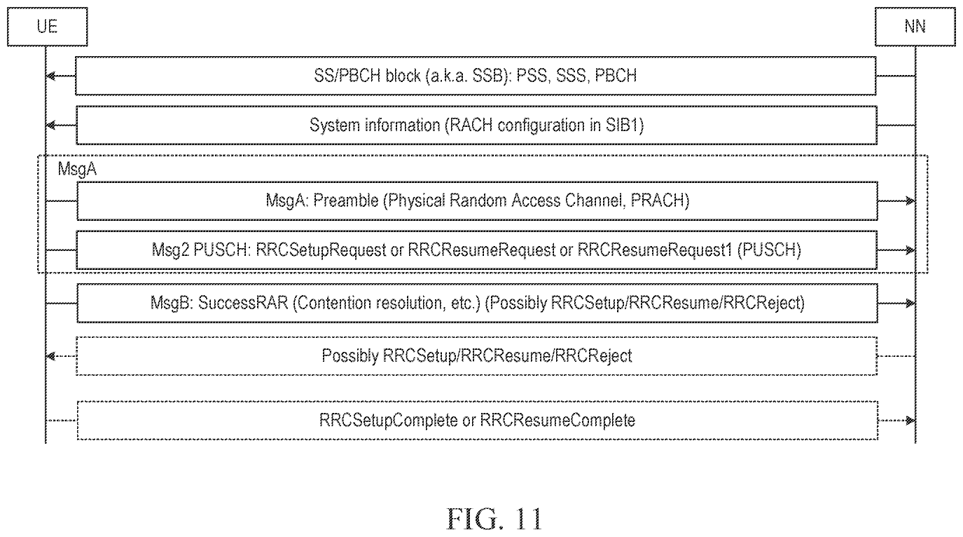

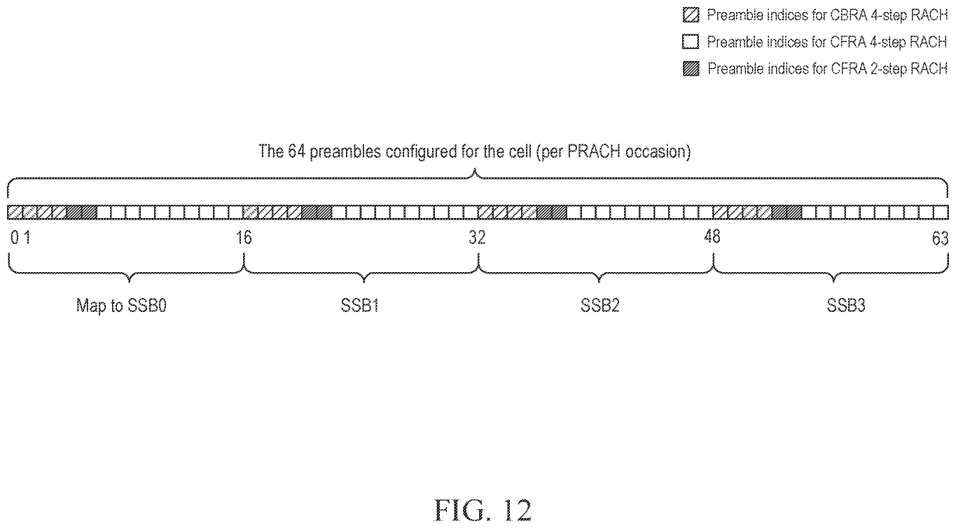

### DETAILED DESCRIPTION

Before describing in detail example embodiments, it is noted that the embodiments reside primarily in combinations of apparatus components and processing steps related to reporting data volume close to small data transmission (SDT) threshold. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a user equipment (UE) such as a user equipment (UE) or a radio network node.

In some embodiments, the non-limiting terms user equipment (UE) and wireless device (WD) a are used interchangeably. The UE herein may be any type of device capable of communicating with a network node or another UE over radio signals, such as wireless device (WD). The UE may also be a radio communication device, target device, device to device (D2D) UE, machine type UE or UE capable of machine to machine communication (M2M), low-cost and/or low-complexity UE, a sensor equipped with UE, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a UE or a network node may be distributed over a plurality of UEs and/or network nodes. In other words, it is contemplated that the functions of the network node and UE described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

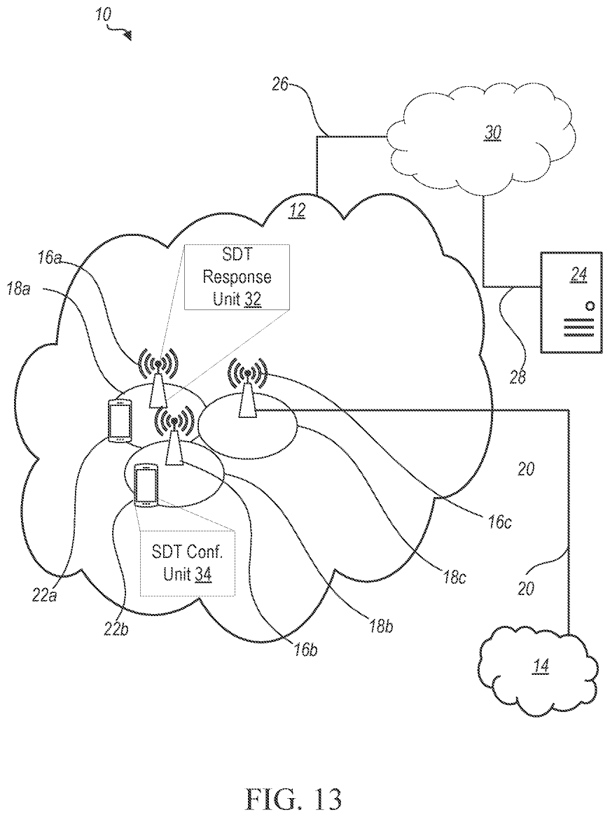

Some embodiments provide reporting data volume close to small data transmission (SDT) threshold. Referring again to the drawing figures, in which like elements are referred to by like reference numerals, there is shown in FIG. 13 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first user equipment (UE) 22a located in coverage area 18a is configured to wirelessly connect to, or be paged by, the corresponding network node 16a. A second UE 22b in coverage area 18b is wirelessly connectable to the corresponding network node 16b. While a plurality of UEs 22a, 22b (collectively referred to as UEs 22) are illustrated in this example, the disclosed embodiments are equally applicable to a situation where a sole UE is in the coverage area or where a sole UE is connecting to the corresponding network node 16. Note that although only two UEs 22 and three network nodes 16 are shown for convenience, the communication system may include many more UEs 22 and network nodes 16.

Also, it is contemplated that a UE 22 may be in simultaneous communication and/or configured to separately communicate with more than one network node 16 and more than one type of network node 16. For example, a UE 22 may have dual connectivity with a network node 16 that supports LTE and the same or a different network node 16 that supports NR. As an example, UE 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 13 as a whole enables connectivity between one of the connected UEs 22a, 22b and the host computer 24. The connectivity may be described as an over-the-top (OTT) connection. The host computer 24 and the connected UEs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected UE 22a. Similarly, the network node 16 need not be aware of the future routing of an outgoing uplink communication originating from the UE 22a towards the host computer 24.

A network node 16 is configured to include an SDT response unit 32 which is configured to determine a number of UEs to be in a connected state based at least in part on the SDT feedback. A UE 22 is configured to include an SDT configuration unit 34 which is configured to configure feedback to the network node, the feedback being based at least in part on successful and unsuccessful SDT procedures.

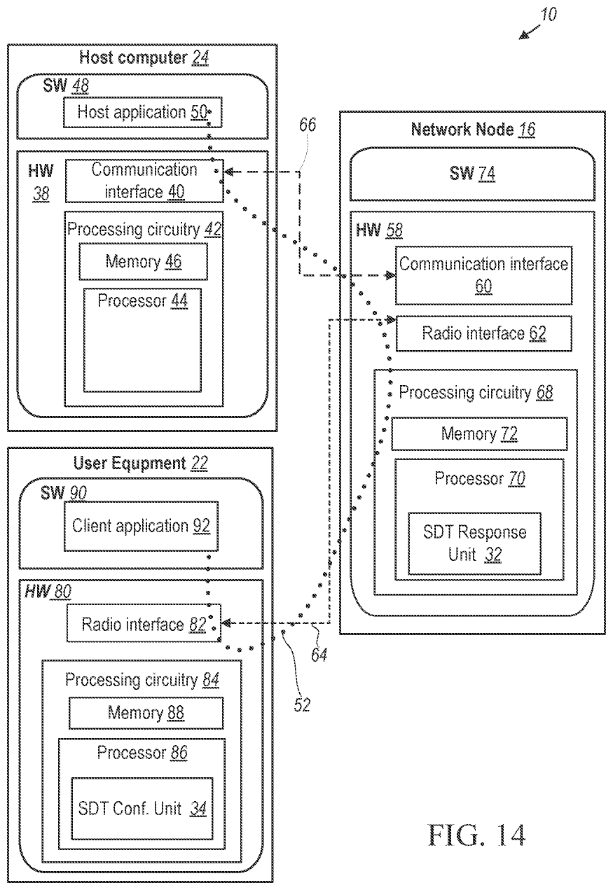

Example implementations, in accordance with an embodiment, of the UE 22, network node 16 and host computer 24 discussed in the preceding paragraphs will now be described with reference to FIG. 14. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a UE 22 connecting via an OTT connection 52 terminating at the UE 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the UE 22.

The communication system 10 further includes a network node 16 provided in a communication system 10 and including hardware 58 enabling it to communicate with the host computer 24 and with the UE 22. The hardware 58 may include a communication interface 60 for setting up and maintaining a wired or wireless connection with an interface of a different communication device of the communication system 10, as well as a radio interface 62 for setting up and maintaining at least a wireless connection 64 with a UE 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10. In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include an SDT response unit 32 which is configured to determine a number of UEs to be in a connected state based at least in part on the SDT feedback.

The communication system 10 further includes the UE 22 already referred to. The UE 22 may have hardware 80 that may include a radio interface 82 configured to set up and maintain a wireless connection 64 with a network node 16 serving a coverage area 18 in which the UE 22 is currently located. The radio interface 82 may be formed as or may include, for example, one or more RF transmitters, one or more RF receivers, and/or one or more RF transceivers.

The hardware 80 of the UE 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the UE 22 may further comprise software 90, which is stored in, for example, memory 88 at the UE 22, or stored in external memory (e.g., database, storage array, network storage device, etc.) accessible by the UE 22. The software 90 may be executable by the processing circuitry 84. The software 90 may include a client application 92. The client application 92 may be operable to provide a service to a human or non-human user via the UE 22, with the support of the host computer 24. In the host computer 24, an executing host application 50 may communicate with the executing client application 92 via the OTT connection 52 terminating at the UE 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by UE 22. The processor 86 corresponds to one or more processors 86 for performing UE 22 functions described herein. The UE 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to UE 22. For example, the processing circuitry 84 of the UE 22 may include an SDT configuration unit 34 which is configured to configure feedback to the network node, the feedback being based at least in part on successful and unsuccessful SDT procedures.

In some embodiments, the inner workings of the network node 16, UE 22, and host computer 24 may be as shown in FIG. 14 and independently, the surrounding network topology may be that of FIG. 13.

In FIG. 14, the OTT connection 52 has been drawn abstractly to illustrate the communication between the host computer 24 and the UE 22 via the network node 16, without explicit reference to any intermediary devices and the precise routing of messages via these devices. Network infrastructure may determine the routing, which it may be configured to hide from the UE 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the UE 22 and the network node 16 is in accordance with the teachings of the embodiments described throughout this disclosure.

One or more of the various embodiments improve the performance of OTT services provided to the UE 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and UE 22, in response to variations in the measurement results. The measurement procedure and/or the network functionality for reconfiguring the OTT connection 52 may be implemented in the software 48 of the host computer 24 or in the software 90 of the UE 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary UE signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the UE 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the UE 22, and/or preparing/terminating/maintaining/supporting/ending in receipt of a transmission from the UE 22.

In some embodiments, the host computer 24 includes processing circuitry 42 and a communication interface 40 that is configured to a communication interface 40 configured to receive user data originating from a transmission from a UE 22 to a network node 16. In some embodiments, the UE 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

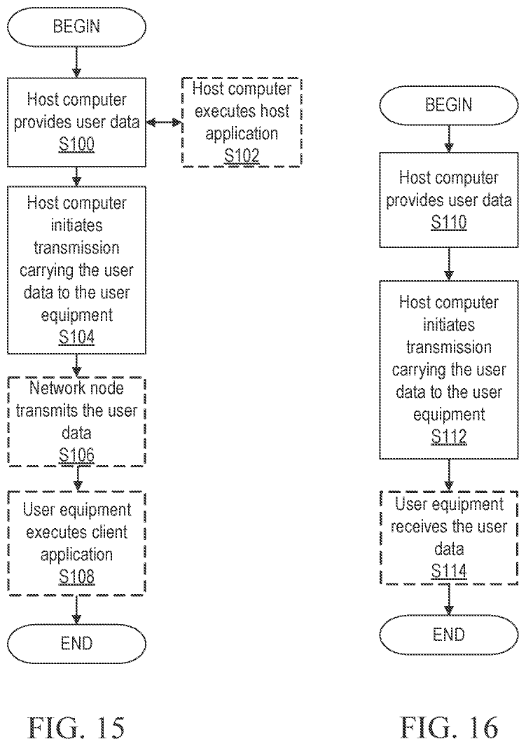

Although FIGS. 13 and 14 show various “units” such as SDT response unit 32, and SDT configuration unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry. FIG. 15 is a flowchart illustrating an example method implemented in a communication system, such as, for example, the communication system of FIGS. 13 and 14, in accordance with one embodiment. The communication system may include a host computer 24, a network node 16 and a UE 22, which may be those described with reference to FIG. 14. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the UE 22 (Block S104). In an optional third step, the network node 16 transmits to the UE 22 the user data which was carried in the transmission that the host computer 24 initiated, in accordance with the teachings of the embodiments described throughout this disclosure (Block S106). In an optional fourth step, the UE 22 executes a client application, such as, for example, the client application 92, associated with the host application 50 executed by the host computer 24 (Block S108).

FIG. 16 is a flowchart illustrating an example method implemented in a communication system, such as, for example, the communication system of FIG. 13, in accordance with one embodiment. The communication system may include a host computer 24, a network node 16 and a UE 22, which may be those described with reference to FIGS. 13 and 14. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the UE 22 (Block S112). The transmission may pass via the network node 16, in accordance with the teachings of the embodiments described throughout this disclosure. In an optional third step, the UE 22 receives the user data carried in the transmission (Block S114).

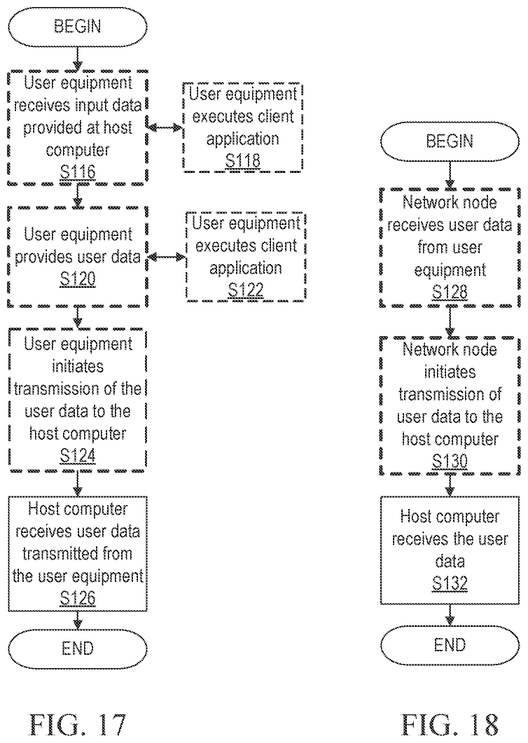

FIG. 17 is a flowchart illustrating an example method implemented in a communication system, such as, for example, the communication system of FIG. 13, in accordance with one embodiment. The communication system may include a host computer 24, a network node 16 and a UE 22, which may be those described with reference to FIGS. 13 and 14. In an optional first step of the method, the UE 22 receives input data provided by the host computer 24 (Block S116). In an optional substep of the first step, the UE 22 executes the client application 92, which provides the user data in reaction to the received input data provided by the host computer 24 (Block S118). Additionally or alternatively, in an optional second step, the UE 22 provides user data (Block S120). In an optional substep of the second step, the UE provides the user data by executing a client application, such as, for example, client application 92 (Block S122). In providing the user data, the executed client application 92 may further consider user input received from the user. Regardless of the specific manner in which the user data was provided, the UE 22 may initiate, in an optional third substep, transmission of the user data to the host computer 24 (Block S124). In a fourth step of the method, the host computer 24 receives the user data transmitted from the UE 22, in accordance with the teachings of the embodiments described throughout this disclosure (Block S126).

FIG. 18 is a flowchart illustrating an example method implemented in a communication system, such as, for example, the communication system of FIG. 13, in accordance with one embodiment. The communication system may include a host computer 24, a network node 16 and a UE 22, which may be those described with reference to FIGS. 13 and 14. In an optional first step of the method, in accordance with the teachings of the embodiments described throughout this disclosure, the network node 16 receives user data from the UE 22 (Block S128). In an optional second step, the network node 16 initiates transmission of the received user data to the host computer 24 (Block S130). In a third step, the host computer 24 receives the user data carried in the transmission initiated by the network node 16 (Block S132).

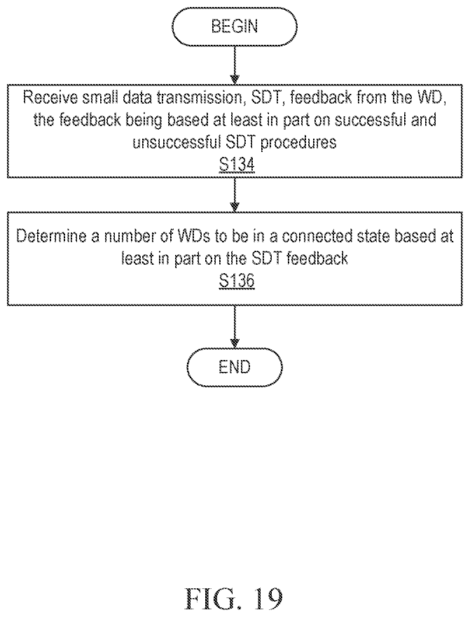

FIG. 19 is a flowchart of an example process in a network node 16 for reporting data volume close to small data transmission (SDT) threshold. One or more blocks described herein may be performed by one or more elements of network node 16 such as by one or more of processing circuitry 68 (including the SDT response unit 32), processor 70, radio interface 62 and/or communication interface 60. Network node 16 such as via processing circuitry 68 and/or processor 70 and/or radio interface 62 and/or communication interface 60 is configured to receive small data transmission, SDT, feedback from the UE, the feedback being based at least in part on successful and unsuccessful SDT procedures (Block S134). The process also includes determining a number of UEs to be in a connected state based at least in part on the SDT feedback (Block S136).

In some embodiments, the SDT feedback is based at least in part on whether an SDT volume exceeds a volume threshold. In some embodiments, the SDT feedback includes a pending uplink data volume. In some embodiments, the SDT feedback is based at least in part on whether an SDT reference signal received power exceeds a power threshold. In some embodiments, the SDT feedback includes a reference signal received power, RSRP.

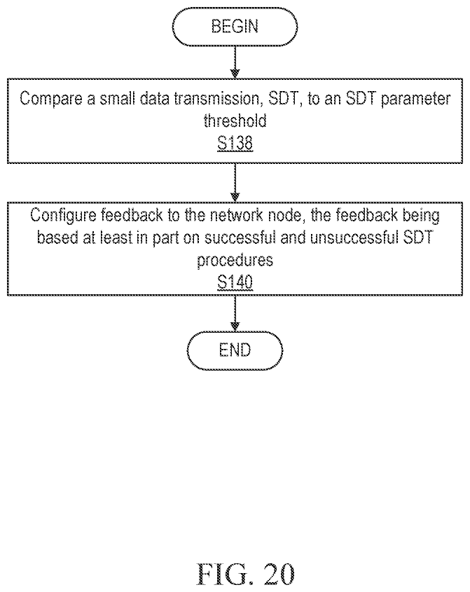

FIG. 20 is a flowchart of an example process in a UE 22 according to some embodiments of the present disclosure. One or more blocks described herein may be performed by one or more elements of UE 22 such as by one or more of processing circuitry 84 (including the SDT configuration unit 34), processor 86, radio interface 82 and/or communication interface 60. UE 22 such as via processing circuitry 84 and/or processor 86 and/or radio interface 82 is configured to compare a small data transmission, SDT, to an SDT parameter threshold (S138). The process incudes configuring feedback to the network node, the feedback being based at least in part on successful and unsuccessful SDT procedures (Block S140).

In some embodiments, the SDT feedback is based at least in part on whether an SDT volume exceeds a volume threshold. In some embodiments, the SDT feedback includes a pending uplink data volume. In some embodiments, the SDT feedback is based at least in part on whether an SDT reference signal received power exceeds a power threshold. In some embodiments, the SDT feedback includes a reference signal received power, RSRP.

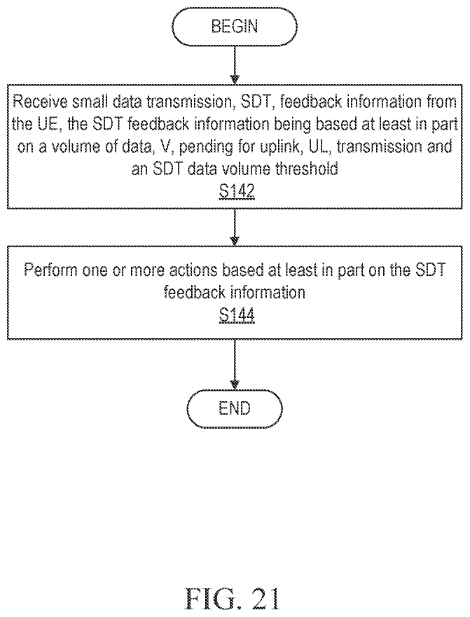

FIG. 21 is a flowchart of an example process in a network node 16 for reporting data volume close to small data transmission (SDT) threshold. One or more blocks described herein may be performed by one or more elements of network node 16 such as by one or more of processing circuitry 68 (including the SDT response unit 32), processor 70, radio interface 62 and/or communication interface 60. Network node 16 such as via processing circuitry 68 and/or processor 70 and/or radio interface 62 and/or communication interface 60 is configured to receive (Block S142) small data transmission (SDT) feedback information from the UE 22, where the SDT feedback information is based at least in part on a volume of data (V) pending for uplink (UL) transmission and an SDT data volume threshold, and perform (Block S144) one or more actions based at least in part on the SDT feedback information.

In some embodiments, the volume of data (V) represents an amount of UL data awaiting transmission across one or more radio bearers for which SDT is enabled in the UE 22.

In some other embodiments, one or both of: 1) if the volume of data (V) is equal to or less than the SDT data volume threshold plus a first offset parameter (D), the SDT feedback information includes one or both of: 1a) information associated with the volume of data pending for UL transmission; and 1b) a first indication indicating that the volume of data (V) pending for UL transmission is equal to or less than the SDT data volume threshold plus the first offset parameter (D); and 2) the SDT feedback information includes the first indication indicating that a difference between the size of the volume of data pending for UL transmission and the SDT data volume threshold is a percentage of the SDT data volume threshold.

In some embodiments, the first offset parameter (D) is based on the SDT data volume threshold.

In some other embodiments, one or both of: 1) the SDT data volume threshold is associated with a reference signal received power (RSRP) threshold; and 2) if the UE 22 supports SDT, a measured RSRP is above the RSRP threshold, and SDT is not used, the SDT feedback information includes a second indication indicating whether the volume of data (V) is greater than the SDT data volume threshold plus the first offset parameter (D).

In some embodiments, if the volume of data (V) is greater than or equal to the SDT data volume threshold minus a second offset parameter (D_{low}) and the volume of data (V) is less than or equal to the SDT data volume threshold plus a third offset parameter (D_{high}) one or both of: 1) the SDT feedback information includes information associated with the volume of data pending for UL transmission; and 2) a third indication indicating that the volume of data (V) is greater than or equal to the SDT data volume threshold minus the second offset parameter (D_{low}) and the volume of data (V) is less than or equal to the SDT data volume threshold plus the third offset parameter (D_{high}), where the third offset parameter (D_{high}) is greater than the second offset parameter (D_{low}).

In some other embodiments, the SDT feedback information includes a parameter describing a cause for not using SDT.

In some embodiments, the SDT feedback information includes a fourth indication indicating the volume of data (V) and a first relation to the SDT data volume threshold, and a measured RSRP, and a second relation to an RSRP threshold.

In some other embodiments, the SDT feedback information is comprised in a random access report.

In some embodiments, the SDT feedback information is received from the UE 22 according to one or more of: 1) per each random access procedure; 2) in a random access portion of a radio link failure report or a connection establishment failure report; 3) in an information element associated with a random access information parameter; and 4) per random access attempt.

In some other embodiments, the one or more actions includes adjusting SDT data volume threshold based at least in part on the SDT feedback information, determining an SDT configuration; and transmitting the SDT configuration to the UE 22.

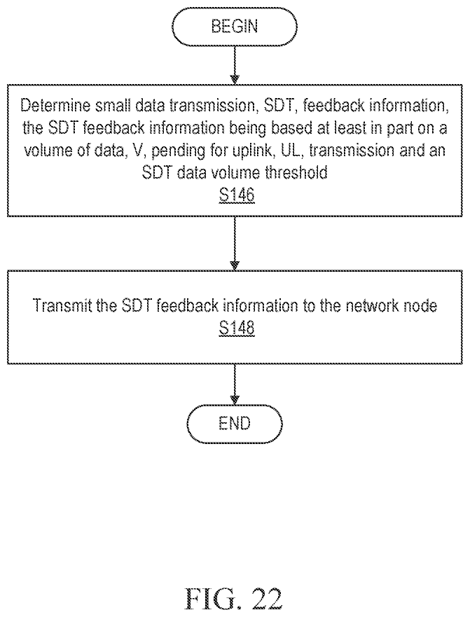

FIG. 22 is a flowchart of an example process in a UE 22 according to some embodiments of the present disclosure. One or more blocks described herein may be performed by one or more elements of UE 22 such as by one or more of processing circuitry 84 (including the SDT configuration unit 34), processor 86, radio interface 82 and/or communication interface 60. UE 22 such as via processing circuitry 84 and/or processor 86 and/or radio interface 82 is configured to determine (Block S146) small data transmission (SDT) feedback information, where the SDT feedback information is based at least in part on a volume of data (V) pending for uplink (UL) transmission and an SDT data volume threshold, and transmit (Block S148) the SDT feedback information to the network node 16.

In some embodiments, the volume of data (V) represents an amount of UL data awaiting transmission across one or more radio bearers for which SDT is enabled in the UE 22.

In some other embodiments, one or both of: 1) if the volume of data (V) is equal to or less than the SDT data volume threshold plus a first offset parameter (D), the SDT feedback information includes one or both of: 1a) information associated with the volume of data pending for UL transmission and 1b) a first indication indicating that the volume of data (V) pending for UL transmission is equal to or less than the SDT data volume threshold plus the first offset parameter (D); and 2) the SDT feedback information includes the first indication indicating that a difference between the size of the volume of data pending for UL transmission and the SDT data volume threshold is a percentage of the SDT data volume threshold.

In some embodiments, the first offset parameter (D) is based on the SDT data volume threshold.

In some other embodiments, one or both of: 1) the SDT data volume threshold is associated with a reference signal received power (RSRP) threshold; and 2) if the UE 22 supports SDT, a measured RSRP is above the RSRP threshold, and SDT is not used, the SDT feedback information includes a second indication indicating whether the volume of data (V) is greater than the SDT data volume threshold plus the first offset parameter (D).

In some embodiments, if the volume of data (V) is greater than or equal to the SDT data volume threshold minus a second offset parameter (D_{low}) and the volume of data (V) is less than or equal to the SDT data volume threshold plus a third offset parameter (D_{high}) one or both of: 1) the SDT feedback information includes information associated with the volume of data pending for UL transmission; and 2) a third indication indicating that the volume of data (V) is greater than or equal to the SDT data volume threshold minus the second offset parameter (D_{low}) and the volume of data (V) is less than or equal to the SDT data volume threshold plus the third offset parameter (D_{high}), where the third offset parameter (D_{high}) is greater than the second offset parameter (D_{low}).

In some other embodiments, the SDT feedback information includes a parameter describing a cause for not using SDT.

In some embodiments, the SDT feedback information includes a fourth indication indicating the volume of data (V) and a first relation to the SDT data volume threshold and a measured RSRP, and a second relation to an RSRP threshold.

In some other embodiments, the SDT feedback information is comprised in a random access report.

In some embodiments, the SDT feedback information is transmitted from the UE 22 according to one or more of: 1) per each random access procedure; 2) in a random access portion of a radio link failure report or a connection establishment failure report; 3) in an information element associated with a random access information parameter; and 4) per random access attempt.

In some other embodiments, one or both of: 1) transmitting the SDT feedback information to the network node 16 triggers the network node 16 to one or both of: 1a) adjust SDT data volume threshold based at least in part on the SDT feedback information; and 1b) determine an SDT configuration; and 2) the method further includes receiving the SDT configuration from the network node 16.

Having described the general process flow of arrangements of the disclosure and having provided examples of hardware and software arrangements for implementing the processes and functions of the disclosure, the sections below provide details and examples of arrangements for reporting data volume close to small data transmission (SDT) threshold.

In some embodiments, the volume of data that is waiting for uplink transmission in the UE 22, which may trigger SDT and which thus is compared with a SDT data volume threshold. For example, the sdt-DataVolumeThreshold-r17 IE in 3GPP TS 38.331 version 17.3.0 may be the SDT data volume threshold, which may be in 3GPP TS 38.300 version 17.3.0 described as the amount of UL data awaiting transmission across all radio bearers for which SDT is enabled in the UE 22. This data volume is herein also referred to with a variety of equivalent expressions, e.g., “pending data volume”, “pending data amount”, “volume of pending data”, “amount of pending data”, “volume of the pending data”, “amount of the pending data”, “volume of the data that is pending”, “amount of the data that is pending”, “volume of data waiting to the transmitted”, “amount of data waiting to be transmitted”, “volume of the data waiting to be transmitted”, “amount of the data waiting to be transmitted”, “volume of the data that is waiting to be transmitted”, “amount of the data that is waiting to be transmitted”, “volume of the data pending transmission”, “amount of data pending transmission”, “volume of the data awaiting transmission”, “amount of data awaiting transmission”, etc. Furthermore, in all of these equivalent terms/expressions “data” may be replaced by “UL data” or “uplink data”.

In some other embodiments, the SDT data volume threshold (which is specified as the sdt-DataVolumeThreshold-r17 IE in 3GPP TS 38.331 version 17.3.0) is also referred to as the “SDTthreshold”. The sdt-DataVolumeThreshold-r17 IE is expressed in bytes.

In some embodiments, the SDT RSRP threshold (which is specified as the sdt-RSRP-Threshold-r17 IE in 3GPP TS 38.331 version 17.3.0) is also referred to as the “RSRPthreshold”. The sdt-RSRP-Threshold-r17 IE is expressed in dBm.

In some other embodiments, the measured RSRP is also referred to as the “RSRP of the downlink pathloss reference” (in particular in 3GPP TS 38.321 version 17.3.0). Measured RSRP may be expressed in dBm, e.g., in the form of a dBm range, e.g., indicated as an RSRP-Range IE.

In some embodiments, the terms “node”, “network”, “network node” and “RAN node” are used interchangeably, typically referring to a gNB.

In some other embodiments, the disclosed solution is herein described mainly in terms of 5G/NR, but the disclosed solution may be equally applicable (with some adaptations) to other RATs, including future RATs such as 6G.

In some embodiments, the terms information element (IE) and field are used interchangeably. Also, the term parameter may be used to denote the same concept.

Further, parameters/IEs/fields used in ASN.1 code as well as in procedural text in the 3GPP RRC specification for 5G/NR, i.e., 3GPP TS 38.331 version 17.3.0, are often named with a suffix indicating the number of the release of the 3GPP standard the parameter/IE/field was introduced in (e.g., the suffix “-r17” for a parameter/IE/field introduced in release 17 of the 3GPP standard, or the suffix “-v17xy” for an extension of, or complement to, a parameter/IE/field, where “v17xy” indicates the version of the release 17 RRC specification, e.g., version 17.3.0). Parameters/IEs/fields following this naming convention are typically referred to both with and without the suffix, where the name including the suffix is used in the ASN.1 code (and thus defines the formal name from the ASN.1 compiler's perspective), while the name without the suffix is used in running text, e.g., in field descriptions and procedural text. Relevant examples in the context of this disclosure include the parameters/IEs/fields sdt-DataVolumeThreshold-r17/sdt-DataVolumeThreshold and sdt-RSRP-Threshold-r17/sdt-RSRP-Threshold. In this disclosure, both name variants may occur for various parameters/IEs/fields.

In some other embodiments, the terms RACH occasion and PRACH occasion are used interchangeably herein (and the abbreviation RO refers to both).

In some other embodiments, the terms “preamble partition” and “preamble range partition” are used interchangeably herein.

According to one aspect, a first action or measure to address the problems of existing technology is to specify that a UE 22 may provide SDT related feedback information to the network node not only when an SDT attempt/procedure fails, but also for successful SDT procedures. The feedback information may be included in a report, e.g., an RA report (i.e., the RA-Report-r16 IE), an RLF report (i.e., in the RLF-Report-r6 IE), a connection establishment failure report (e.g., in the ConnEstFailReport-r16 IE). This may increase the scope, amount, richness and usefulness of the SDT related feedback information provided to the network.

The above is assumed in some embodiments, while other embodiments assume that the concerned SDT attempt failed. In yet other embodiments, SDT related feedback information may be reported from the UE 22 to the network also in cases where SDT was not triggered, e.g., because the data volume pending for transmission in the UE 22 exceeded the SDT data volume threshold, if the pending data volume exceeded the SDT data volume threshold with a no more than a configured or specified amount (e.g., a comparatively small amount) such as if the pending data volume V was not greater than SDTthreshold+D, i.e., V<SDTthreshold+D (where D is an amount of data which typically, but not necessarily, satisfies D<SDTthreshold).

In some embodiments, reporting/indicating/indication refers to inclusion of information in the RA related feedback information sent from a UE 22 to the network (e.g., to a gNB or an eNB), e.g., in the form of a RA-Report-r16 IE or in the RA related information in an RLF-Report-r16 IE or in the RA related information in a ConnEstFailReport-r16 IE in a UEInformationReponse message in NR or in a new complementing RACH-Report-vXYZQ IE in a nonCriticalExtension of the UEInformationResponse message in LTE.

SDT feedback logging/reporting options focusing mainly on the pending UL data volume and its relation to the SDT data volume threshold (mainly targeting optimization of the SDT data volume threshold)

Below is listed a number of (non-limiting) options for reporting/indication of various information related to SDT, in particular information related to the data pending for transmission in the UE 22, often associated with one or more condition(s). In the options in the list, the volume of data pending for transmission in the UE 22 (at the time of random access triggering (as one alternative) or at the time of random access initiation (as another alternative)) is denoted as “V” (which thus represents the amount of UL data awaiting transmission across all radio bearers for which SDT is enabled in the UE 22), e.g., expressed in bytes, and an SDT data volume threshold (e.g., the sdt-DataVolumeThreshold-r17 IE) is denoted as “SDTthreshold”, which in accordance with the definition of the sdt-DataVolumeThreshold-r17 IE in 3GPP TS 38.331 version 17.3.0 is expressed in bytes. The sdt-RSRP-Threshold-r17 IE is also referred to as the “RSRPthreshold”, is the RSRP threshold the measured RSRP is compared with, and it is expressed in dBm. Furthermore, the offset parameters denoted as D, D_{low} and D_{high} represent data amounts, or differences in data amounts, and are preferably expressed in bytes. D, D_{low} and D_{high} may refer to Δ, Δ_{low}, and Δ_{high}, respectively.

Below is a non-limiting list of options for logging, reporting, indicating various SDT related information from the UE 22 to the network (in particular information related to the data pending for transmission in the UE 22), generally expressed with a UE 22 perspective, e.g., as an action a UE 22 is expected to perform (note that the options are numbered for the sake of facilitating referencing, but it does not imply any sequence of priority):
1. Report the pending data volume V (e.g., expressed in bytes) if 0<V≤SDTthreshold+D.
2. Report the pending data volume V (e.g., expressed in bytes) if SDTthreshold-D_{low}≤V≤SDTthreshold+D_{high}.
3. Indicate that the pending data volume V (e.g., expressed in bytes) was V≤SDTthreshold+D.
4 Indicate that the pending data volume V satisfied SDTthreshold-D_{low}≤V≤SDTthreshold+D_{high}.
   a. In one variant also indicate whether V was V≤SDTthreshold or V>SDTthreshold.
5. If SDT was used, indicate whether the pending data volume V was SDTthreshold-D≤V or V<SDTthreshold-D. (Note that if the UE 22 used SDT, the pending data volume V was V≤SDTthreshold.) This may be combined with option 0 below, in which case D_{low} would be used for this condition and D_{high} would be used for the condition in option 0 below (where D_{low} and D_{high} may be equal or different from each other).
6. If the UE 22 supports SDT (and there were RA resources for the SDT feature, e.g., a preamble partition configured in the cell, or rather “a set of random access resources” as it says in 3GPP TS 38.321 version 17.3.0), and the measured RSRP was above the SDT RSRP threshold, but SDT was not used, indicate whether the pending data volume V was V≤SDTthreshold+D. (Note that if the UE 22 supports SDT, but did not use SDT despite the measured RSRP being above the SDT RSRP threshold, the pending data volume V was V>SDTthreshold.) This may be combined with option 0 above, in which case D_{high} would be used for this condition and D_{low} would be used for the condition in the option above (where D_{low} and D_{high} may be equal or different from each other).
7. If the UE 22 supports SDT (and there were RA resources for the SDT feature, e.g., a preamble partition configured in the cell, or rather “a set of random access resources” as it says in TS 38.321 version 17.3.0), and the pending UL data volume, V, was V≤SDTthreshold+D, but the UE 22 did not use SDT, then indicate that this was the case.
   a. As one option, indicate the reason for not using SDT (e.g., captured in a parameter denoted as “nonSDT-Cause”):
      i. the pending UL data volume, V, was V>SDTthreshold,
      ii. the RSRP was RSRP<sdt-RSRP-Threshold-r17 (where the RSRP is the RSRP of the downlink pathloss reference), or
      iii. the pending UL data volume, V, was V>SDTthreshold AND the RSRP was RSRP<sdt-RSRP-Threshold-r17 (where the RSRP is the RSRP of the downlink pathloss reference).
   b. As another option, indicate the pending UL data volume, V, and the measured RSRP in terms of their relations to respective relevant thresholds:
      i. the pending UL data volume, V, was V>SDTthreshold and the RSRP was RSRP>sdt-RSRP-Threshold-r17 (where the RSRP is the RSRP of the downlink pathloss reference),
      ii. the RSRP was RSRP<sdt-RSRP-Threshold-r17 (where the RSRP is the RSRP of the downlink pathloss reference) and the pending UL data volume, V, was V≤SDTthreshold, or
      iii. the pending UL data volume, V, was V>SDTthreshold and the RSRP was RSRP<sdt-RSRP-Threshold-r17 (where the RSRP is the RSRP of the downlink pathloss reference).
8. If the UE 22 supports SDT (and there were RA resources for the SDT feature, e.g., a preamble partition configured in the cell, or rather “a set of random access resources” as it says in TS 38.321 version 17.3.0), and the pending UL data volume, V, was V≤SDTthreshold+D, but the UE 22 did not use SDT, then indicate the reason for not using SDT (e.g., captured in a parameter denoted as “nonSDT-Cause”):
   a. the pending UL data volume, V, was V>SDTthreshold,
   b. the RSRP was RSRP<sdt-RSRP-Threshold-r17 (where the RSRP is the RSRP of the downlink pathloss reference), or
   c. the pending UL data volume, V, was V>SDTthreshold AND the RSRP was RSRP<sdt-RSRP-Threshold-r17 (where the RSRP is the RSRP of the downlink pathloss reference).
9. If the UE 22 supports SDT (and there were RA resources for the SDT feature, e.g., a preamble partition configured in the cell, or rather “a set of random access resources” as it says in TS 38.321 version 17.3.0), and the pending UL data volume, V, was V≤SDTthreshold+D, but the UE 22 did not use SDT, then indicate the pending UL data volume, V, and the measured RSRP in terms of their relations to respective relevant thresholds:
   a. the pending UL data volume, V, was V>SDTthreshold and the RSRP was RSRP>sdt-RSRP-Threshold-r17 (where the RSRP is the RSRP of the downlink pathloss reference),
   b. the RSRP was RSRP<sdt-RSRP-Threshold-r17 (where the RSRP is the RSRP of the downlink pathloss reference) and the pending UL data volume, V, was V≤SDTthreshold, or
   c. the pending UL data volume, V, was V>SDTthreshold and the RSRP was RSRP<sdt-RSRP-Threshold-r17 (where the RSRP is the RSRP of the downlink pathloss reference).
10. Use the following combination of conditional indications in the RA report:
   a. If the UE 22 used SDT, report the pending data volume V.
   b. Optionally: If the UE 22 used SDT, indicate if the sdt-RSRP-Threshold was not configured and optionally the latest measurement of the RSRP of the downlink pathloss reference
   c. If the UE 22 supports SDT (and there were RA resources for the SDT feature, e.g., a preamble partition configured in the cell, or rather “a set of random access resources” as it says in TS 38.321 version 17.3.0), and the pending UL data volume, V, was V≤SDTthreshold+D, but the UE 22 did not use SDT, then include in the RA report the indication(s) as described in any of the options 0, 0 or 0.
   d. For any other case where the UE 22 did not use SDT, do not indicate anything in the RA report.
11. Use the following combination of conditional indications in the RA report:
   a. If the UE 22 used SDT, report the pending data volume V.
   b. If the UE 22 supports SDT (and there were RA resources for the SDT feature, e.g., a preamble partition configured in the cell, or rather “a set of random access resources” as it says in TS 38.321 version 17.3.0), and the measured RSRP was above the SDT RSRP threshold, but the UE 22 did not use SDT, then indicate whether the pending UL data volume, V, was V≤SDTthreshold+D.
   c. If the UE 22 supports SDT (and there were RA resources for the SDT feature, e.g., a preamble partition configured in the cell, or rather “a set of random access resources” as it says in TS 38.321 version 17.3.0), and the measured RSRP was below the SDT RSRP threshold (i.e., the UE 22 did not use SDT), and the pending UL data volume, V, was V≤SDTthreshold+D, indicate in the RA report:
      i. the measured RSRP or an indication that the measured RSRP was below the SDT RSRP threshold, and/or
      ii. the pending UL data volume V or an indication of whether the pending UL data volume V was V≤SDTthreshold or SDTthreshold<V≤SDTthreshold+D.
   d. For any other case where the UE 22 did not use SDT, do not indicate anything in the RA report.

For all the cases above where conditions on the RSRP measurements made by the UE 22 to determine if SDT may be initiated may be checked by the UE 22 and reported to the network. Considering DRSRP_{low} a certain delta in RSRP measurements to identify a lower than RSRP threshold point, while DRSRP_{high} a certain delta in RSRP measurements to identify a higher than RSRP threshold point, the methods also cover the possibility for the UE 22 to report:
whether the RSRP measurement<RSRP threshold+DRSRP_{high}.
whether the RSRP measurement>RSRP threshold−DRSRP_{low}.
whether the RSRP threshold−DRSRP_{low}<RSRP measurement<RSRP threshold+DRSRP_{high}.

In some embodiments, whether SDT optimization is to be performed may be based on whether V is within “SDT” and “SDT+offset”, where “offset” can be a new parameter, and UE 22 sends SDT feedback when V is in the range above (SDT, SDT+offset). “SDT+offset” value can be included or excluded.

The above conditions reported by the UE 22 may be combined with all other conditions described above. In a non-limiting example, regarding case 7 above, if the UE 22 supports SDT (and there were RA resources for the SDT feature, e.g., a preamble partition configured in the cell, or rather “a set of random access resources” as it says in 3GPP TS 38.321 version 17.3.0), and the pending UL data volume, V, was V≤SDTthreshold+D, but the UE 22 did not use SDT, then an indication may be provided, wherein the indication indicates that this was the case.

As one option, the reason for not using SDT (e.g., captured in a parameter denoted as “nonSDT-Cause”) may be indicated. Each of the below reasons may be associated to a corresponding “cause” flag, and the UE 22 may report one or more of these cause flags:
The pending UL data volume, V, was V>SDTthreshold.
The RSRP was RSRP<sdt-RSRP-Threshold-r17-DRSRP_{low} (where the RSRP is the RSRP of the downlink pathloss reference).
The pending UL data volume, V, was V>SDTthreshold AND the RSRP was RSRP<sdt-RSRP-Threshold-r17-DRSRP_{low} (where the RSRP is the RSRP of the downlink pathloss reference).
The pending UL data volume, V, was V>SDTthreshold AND the RSRP was sdt-RSRP-Threshold-r17<RSRP<sdt-RSRP-Threshold-r17-DRSRP_{low} (where the RSRP is the RSRP of the downlink pathloss reference).
The pending UL data volume, V, was V<SDTthreshold AND the RSRP was sdt-RSRP-Threshold-r17<RSRP<sdt-RSRP-Threshold-r17-DRSRP_{low} (where the RSRP is the RSRP of the downlink pathloss reference).
The pending UL data volume, V, was V<SDTthreshold AND the RSRP was RSRP<sdt-RSRP-Threshold-r17-DRSRP_{low} (where the RSRP is the RSRP of the downlink pathloss reference).
If the selected UL carrier is not configured with CG-SDT and if the TA (time alignment) for CG-SDT is not valid.
If none of SSBs configured for CG-SDT have a measured SS-RSRP above the cg-SDT-RSRP-ThresholdSSB.
If no Random Access resources for performing RA-SDT are available/configured on the selected UL carrier.
If for one or more of the logical channels having data available for transmission the configured grant is not configured or it is configured to false for the corresponding logical channel.

Further, for cases where SDT was used, the UE 22 may indicate:
whether RSRP threshold+DRSRP_{high}<measured RSRP.
whether RSRP threshold+DRSRP_{high}>measured RSRP.

For cases where SDT was not used, the UE 22 may indicate:
whether RSRP threshold−DRSRP_{low}<measured RSRP.
whether RSRP threshold−DRSRP_{low}>measured RSRP.

In a non-limiting variant, the value of the (D) considered in the above list of the logging conditions (from bullet 1 to bullet 11) may be determined based on the value of the SDTthreshold (in other words it may be a function of SDTthreshold). In a non-limiting example, (D) is equal to N*SDTthreshold. For example, it may be set to 2*SDTthreshold or 0.5*SDTthreshold. In an embodiment, the value of N may be configured by the network, or it may be hardcoded at the UE 22 (i.e., non-configurable and fixed value).

Any of the above listed options may be indicated per RA procedure, e.g., in the RA report or in the RA related part of the RLF report or in the RA related part of the connection establishment failure report, e.g., by including the SDT feedback information in the RA-Report-r16 IE (for the RA report case) or in the RA-InformationCommon-r16 IE (in the RA report and/or RLF report case) or in the PerRAInfo-r16 IE (in the RA report and/or RLF report and/or connection establishment failure report case).

Any of the above listed options may be indicated per RA attempt, e.g., in the RA report or in the RA related part of the RLF report or in the RA related part of the connection establishment report, e.g., by including the SDT feedback information in the PerRAAttemptInfo-r16 IE.

An additional possibility is that any of the above listed options may be included per sequence of RA attempts for the same SSB/CSI-RS. This may require that the following new IEs are introduced in the UEInformationResponse message (where the names of the new IEs may equally well be different from what is indicated below, as long as the semantics is the same):
A new PerRASSBInfo-vxyzq IE and possibly a new PerRACSI-RSInfo-vxyzq IE, which would include the SDT feedback information.
If a new PerRASSBInfo-vxyzq IE is introduced but not a new PerRACSI-RSInfo-vxyzq IE:
   A new PerRAInfoList-vxyzq IE, which would include a sequence of PerRASSBInfo-vxyzq IE(s). The new PerRAInfoList-vxyzq IE would be included in the RA-InformationCommon-r16 IE.

If a both a new PerRASSBInfo-vxyzq IE and a new PerRACSI-RSInfo-vxyzq IE are introduced:
A new PerRAInfo-vxyzq IE which would be a CHOICE structure including a choice between a PerRASSBInfo-vxyzq IE and a PerRACSI-RSInfo-vxyzq IE.
A new PerRAInfoList-vxyzq IE which would include a sequence of PerRAInfo-vxyzq IE(s). The new PerRAInfoList-vxyzq IE would be included in the RA-Information Common-r16 IE.
   Various SDT Feedback Information that May be Reported for Various Optimizations

The following is a non-limiting list of possible SDT feedback information that may be reported (e.g., included in the RA report or in the RA related part of the RLF report or in the RA related part of the connection establishment report).
SDT configuration information (to relieve the network from having to log and remember and recall what the SDT configuration was when the SDT procedure the reported SDT related feedback information pertains to was performed).
   The SDT data volume threshold (the sdt-DataVolumeThreshold-r17 IE).
   The SDT RSRP threshold (the sdt-RSRP-Threshold-r17 IE).
   The T319a timer start value (the t319a-r17 IE).
   The sdt-LogicalChannelSR-DelayTimer-r17 IE.
Feature combination information involving SDT, e.g., which other feature(s), if any, the SDT feature is grouped with in the feature combination configuration (e.g., in a FeatureCombination-r17 IE in the FeatureCombinationPreambles-r17.
Information allowing the network to determine, recall or identify the SDT configuration that was applied when the SDT procedure that the reported SDT related feedback information pertains to was performed.
   A timestamp of the SDT procedure that the reported SDT related feedback information pertains to (e.g., in the form of a UTC timestamp or a Hyper-SFN combined with an SFN).
   The elapsed time since that the SDT procedure the reported SDT related feedback information pertains to was performed.
The identity of the logical channel group(s) for which the UE 22 triggered SDT procedure and the corresponding per logical channel group amount of UL data awaiting to be transmitted upon SDT trigger.
Information on the radio bearer(s) (e.g., the signaling radio bearer identity, or the data radio bearer identity) for which the UE 22 triggered SDT procedure and the corresponding per radio bearer amount of UL data awaiting to be transmitted upon SDT trigger.
Information on the radio bearer(s) (e.g., the signaling radio bearer identity, or the data radio bearer identity) for which the UE 22 did not trigger SDT and corresponding per radio bearer amount of UL data awaiting to be transmitted.
Whether the SDT procedure was associated to a full I-RNTI (i.e., the UE 22 sent an RRCResumeRequest message) or a short I-RNTI (i.e., the UE 22 sent an RRCResumeRequest1 message).
Whether the SDT procedure was initiated to transmit UL data for a signaling radio bearer only, or for a data radio bearer only, or for both.
whether the SDT procedure was not initiated, although the UE 22 was capable of and The conditions on the amount of data and the coverage (DL RSRP) were fulfilled, due to UL data awaiting to be transmitted in a buffer for at least one radio bearer (signaling radio bearer or data radio bearer) for which SDT is not enabled.
Whether the SDT procedure was initiated, and—while performing the SDT procedure—the UE 22 also initiated a transmission of UL data appearing in a buffer of at least one radio bearer not enabled for SDT, although the volume of UL data for such radio bearer, summed to with the UL data in the buffer of radio bearers enabled for SDT, still satisfies the configured amount of UL data used to determine the possibility for the UE 22 to trigger SDT procedure.
SDT assistance information such as whether single packet or multiple packets are being transmitted.
Whether four-step RA or two-step RA resources where used.
Which NR-U channel was used to transmit UL data during the SDT procedure.
Whether the UL data transmission for which SDT procedure was initiated was preceded by LBT issues.
Data volume pending for transmission that triggered the SDT attempt/procedure.
   Optionally reported per DRB.
Data volume pending for transmission that didn't lead to the SDT operation (i.e., the data volume was greater the SDTthreshold).
Optionally reported per DRB.
DRB(s) (in the form of DRB ID(s)) for which UL data was pending.
Difference between the size of the data volume pending for transmission and the SDT data volume threshold which may be:
   Optionally expressed as difference of data amount.
   Optionally expressed as a fraction, i.e., the fraction of the SDT data volume threshold that the pending data volume represents (where the fraction may be smaller, equal to, or greater than one).
   Optionally expressed as a percentage, i.e., the percentage of the SDT data volume threshold that the pending data volume represents (where the percentage may be smaller, equal to, or greater than 100%).
   Optionally reported only when the pending data volume was equal to or smaller than the SDT data volume threshold.
   Optionally reported when the pending data volume V was in the range SDTthreshold-D_{low}<V<SDTthreshold+D_{high}.
   Optionally reported when the pending data volume V was in the range 0<V<SDTthreshold+D.
   Optionally reported only when an SDT attempt was performed, i.e., if the pending data volume was equal to or smaller than the SDT data volume threshold and the measured RSRP was above the SDT RSRP threshold.
   Optionally reported when the pending data volume V was in the range SDTthreshold-D_{low}<V<SDTthreshold+D_{high} and the measured RSRP was above the SDT RSRP threshold.
   Optionally reported when the pending data volume V was in the range 0<V<SDTthreshold+D and the measured RSRP was above the SDT RSRP threshold.
   Any of the above options, but reported only if the SDT attempt failed.
Measured RSRP, which may be:
   Optionally expressed in dBm.
   Optionally expressed in watt.
   Optionally reported only when the measured RSRP (RSRP_{measured}) was above the SDT RSRP threshold.
   Optionally reported when the measured RSRP (RSRP_{measured}) was in the range RSRPthreshold-D_{low}<RSRP_{measured}<RSRP_{threshold}+D_{high}. (compared either in the linear or domain (e.g., measured in watt) or in the logarithmic domain (e.g., RSRP_{measured} in dBm and D_{low} and D_{high} measured in Db or dBm).
   Optionally reported when the measured RSRP (RSRP_{measured}) was in the range RSRP_{measured}>RSRP_{threshold}+D. (compared either in the linear or domain (e.g., measured in watt) or in the logarithmic domain (e.g., RSRP measured in dBm and D measured in Db or dBm).
   Optionally reported when the pending data volume V was in the range SDTthreshold-D_{low}≤V≤SDTthreshold+D_{high} and the measured RSRP was above the SDT RSRP threshold.
   Optionally reported only when an SDT attempt was performed, i.e., if the measured RSRP was above the SDT RSRP threshold and the data volume pending for transmission was equal to or smaller than the SDT data volume threshold.
The difference between the measured RSRP and the SDT RSRP threshold, which may be:
   Optionally expressed in dB.
   Optionally expressed as a difference in dBm.
   Optionally expressed as a difference in watt.
   Optionally expressed as a fraction of the SDT RSRP threshold (which may be smaller, equal to, or greater than one).
   Expressed as a percentage of the SDT RSRP threshold (which may be smaller, equal to, or greater than 100%).
The value of the T319a timer when the T319a timer was stopped or when it expired (in which case its value was zero).
Time since the last/previous SDT operation, e.g.:
   time since the last/previous successful SDT operation.
   time since the last/previous SDT attempt regardless of outcome of the operation i.e., failed SDT operation or a successful operation.
An indication indicating whether the SDT operation is performed in the same cell in which the UE 22 performed transition to the RRC_Inactive/RRC_IDLE from RRC_connected state or a different cell than the cell in which the UE 22 performed transition to the RRC_Inactive/RRC_IDLE from RRC_Connected state
Failure cause, e.g.,:
   Expiration of timer T319a.
   Lack of confirmation of successfully transmitted data.
   LBT failure preventing RA preamble transmission in shared spectrum.
   LBT failure preventing Msg3 transmission.
   Absence of Random Access Response message (Msg2).
   Absence of MsgB.
   RA contention detected.
   Pending data volume V being SDTthreshold<V≤D.
   RSRP exceeding the RSRP threshold by up to d, where d may be expressed in dB, dBm, watt, fraction or percent.
Any of the above, but reported only if the SDT attempt failed.
Any of the options described herein.

Any of the above listed options may be indicated per RA procedure, e.g., in the RA report or in the RA related part of the RLF report or in the connection establishment failure report. For example, at least one of the above listed options may be indicated by including the SDT feedback information in the RA-Report-r16 IE (for the RA report case) or in the RA-Information Common-r16 IE (in the RA report and/or RLF report case) or in the PerRAInfo-r16 IE (in the RA report and/or RLF report and/or connection establishment failure report case).

Any of the above listed options may be indicated per RA attempt, e.g., in the RA report or in the RA related part of the RLF report or in the RA related part of the connection establishment failure report, e.g., by including the SDT feedback information in the PerRAAttemptInfo-r16 IE.

An additional possibility is that any of the above listed options may be included per sequence of RA attempts for the same SSB/CSI-RS. This may require that the following new IEs are introduced in the UEInformationResponse message (where the names of the new IEs may equally well be different from what is indicated below, as long as the semantics is the same):
A new PerRASSBInfo-vxyzq IE and possibly a new PerRACSI-RSInfo-vxyzq IE, which would include the SDT feedback information.
If a new PerRASSBInfo-vxyzq IE is introduced but not a new PerRACSI-RSInfo-vxyzq IE:
   A new PerRAInfoList-vxyzq IE, which would include a sequence of PerRASSBInfo-vxyzq IE(s). The new PerRAInfoList-vxyzq IE would be included in the RA-InformationCommon-r16 IE.
If a both a new PerRASSBInfo-vxyzq IE and a new PerRACSI-RSInfo-vxyzq IE are introduced:
   A new PerRAInfo-vxyzq IE which would be a CHOICE structure including a choice between a PerRASSBInfo-vxyzq IE and a PerRACSI-RSInfo-vxyzq IE.
   A new PerRAInfoList-vxyzq IE which would include a sequence of PerRAInfo-vxyzq IE(s). The new PerRAInfoList-vxyzq IE would be included in the RA-InformationCommon-r16 IE.

### Possible Conditions for Inclusion of SDT Related Information in the RA Report (or in the RA Related Part of the RLF Report or in the RA Related Part of the Connection Establishment Failure Report)

Below is a list of possible conditions for inclusion of SDT related information in the RA report. The condition may apply to all the SDT related information or to a part of it. Two or more conditions may also be combined or configured in parallel, where for instance one may apply to inclusion of SDT information in the RA report in general (i.e., this condition must be fulfilled for any SDT related information at all to be included), while another condition applies to a part of the SDT related information (meaning that for inclusion of this part of the SDT related information, both the general/overall condition and the second condition must be fulfilled). In the list of conditions, the following definitions apply:
“SDTthreshold” refers to the configured SDT data volume threshold, e.g., the sdt-DataVolumeThreshold-r17 IE in SIB1, which the UE 22 applied in the concerned/reported SDT procedure.
“SDTthresholdMax” refers to the maximum value that may be configured for an SDT data volume threshold, e.g., the maximum value of the sdt-DataVolumeThreshold-r17 IE in SIB1 (i.e., 96000 bytes in version 17.3.0 of 3GPP TS 38.331).

### List of Conditions:

Pending data volume V is 0<V≤SDTthreshold+D.
Pending data volume V is SDTthreshold-D_{low}≤V≤SDTthreshold+D_{high}.
Pending data volume V is 0<V<SDTthresholdMax+D.
Pending data volume V is SDTthresholdMax-D_{low}≤V≤SDTthresholdMax+D_{high}. (SDTthresholdMax is the maximum value that may be configured for an SDT data volume threshold.)
RSRP threshold−DRSRP_{low}<measured RSRP<RSRP threshold.
RSRP threshold−DRSRP_{low}>measured RSRP
The SDT procedure failed.
The SDT procedure failed due to one of a certain set of failure causes (where the set may include one or more cause values), where such failure causes e.g., may be one of the following:
   Expiration of timer T319a.
   Lack of confirmation of successfully transmitted data.
   LBT failure preventing RA preamble transmission in shared spectrum.
   LBT failure preventing Msg3 transmission.
   Absence of Random Access Response message (Msg2).
   Absence of MsgB.
   RA contention detected.
   Pending data volume V being SDTthreshold<V≤D.
   RSRP exceeding the RSRP threshold by up to d, where d may be expressed in dB, dBm, watt, fraction or percent.

### Configuration Signaling

The embodiments described in the previous sections may include a number of new parameters that may be either specified in a standard or configured by the network, i.e., signaled from the network, e.g., a network node 16 to the UE(s) 22. These parameters include one or more of:
D
D_{low}
D_{high}
d
Nₜᵣₐₙₛ
DRSRP_{low}
DRSRP_{high}

In addition, a possible option is to make it at least partly configurable which SDT related feedback data a UE 22 should report, e.g., a subset of the information items listed and described herein.

To this end, any of the above parameters or information items may be configured via signaling from the network, e.g., a network node 16, to a UE 22. One attractive way of doing this is to signal the concerned parameters/information items via the system information, preferably by including the concerned parameter(s) and/or information items in SIB1 where the SDT configuration parameters are currently included (in 3GPP TS 38.331 version 17.3.0), e.g., in a new SDT-ConfigCommonSIB-v17xy IE in a new SIB1-v17xy-IEs IE, which would be a nonCriticalExtension of SIB1.

In some embodiments, one or more of the concerned configuration parameters/information items may be included in dedicated signaling to a UE 22, e.g., RRC signaling such as in an RRCRelease message releasing a UE 22 from RRC_CONNECTED state to RRC_INACTIVE or RRC_IDLE state, or possibly in an RRCReconfiguration message.

In some other embodiments, the concerned configuration parameters/information items may be provided via the system information, preferably SIB1, but to overriding of this configuration may be allowed using dedicated signaling, e.g., by providing selected overriding parameters/information items in an RRCRelease message or an RRCReconfiguration message.

### Signaling of SDT Related Events Across RAN Nodes

Any of the reports generated by the UE 22 and enhanced by means of this disclosure may be signaled by the UE 22 to the gNB-CU-CP, e.g., RA Report, RLF Report, CEF Report. However, the RAN node owning control over RACH configurations and resources is the gNB-DU.

In some embodiments, the events and information described in this disclosure may be eventually signaled to the gNB-DU, e.g., to allow the gNB-DU to apply due changes in RACH configurations and in SDT parameters configuration towards the UE 22, so to optimize usage of SDT.

In one embodiment, such signaling is achieved by allowing the gNB-CU-CP to report to the gNB-DU the full report generated by the UE 22. Current specifications already allow the gNB-CU-CP to report RA Reports and RLF Reports to the gNB-DU. However, there is the need for the gNB-CU-CP to report the connection establishment failure (CEF) report to the gNB-DU, in order to let the gNB-DU know of connection establishment failure cases where SDT failed, and therefore enable collection of information allowing for RACH and UE 22 configuration optimization towards best usage of SDT.

Reporting of the CEF Report including the suggested SDT feedback information described in this application may occur by means of the F1AP: ACCESS AND MOBILITY INDICATION message

In another embodiment, the gNB-CU-CP may signal one or more of the SDT feedback described above and/or SDT feedback information, as part of information elements within signaling messages sent form the gNB-CU-CP to the gNB-DU, over the F1 interface.

In one possible implementation of this disclosure, the feedback information in question may be included in the F1AP: ACCESS AND MOBILITY INDICATION message from the gNB-CU-CP to the gNB-DU.

The following is a nonlimiting list of example embodiments.

Embodiment A1. A network node configured to communicate with a user equipment (UE), the network node configured to, and/or comprising a radio interface and/or comprising processing circuitry configured to:
receive small data transmission, SDT, feedback from the UE, the feedback being based at least in part on successful and unsuccessful SDT procedures; and
performing one or more actions based on based at least in part on the SDT feedback.

Embodiment A2. The network node of Embodiment A1, wherein the SDT feedback is based at least in part on whether an SDT volume exceeds a volume threshold.

Embodiment A3. The network node of Embodiment A2, wherein the SDT feedback includes a pending uplink data volume.

Embodiment A4. The network node of any of Embodiments A1-A3, wherein the SDT feedback is based at least in part on whether an SDT reference signal received power exceeds a power threshold.

Embodiment A5. The network node of Embodiment A4, wherein the SDT feedback includes a reference signal received power, RSRP.

Embodiment B1. A method implemented in a network node, the method comprising:
receiving small data transmission, SDT, feedback from the UE, the feedback being based at least in part on successful and unsuccessful SDT procedures; and
determining a number of UEs to be in a connected state based at least in part on the SDT feedback.

Embodiment B2. The method of Embodiment B1, wherein the SDT feedback is based at least in part on whether an SDT volume exceeds a volume threshold.

Embodiment B3. The method of Embodiment B2, wherein the SDT feedback includes a pending uplink data volume.

Embodiment B4. The method of any of Embodiments B1-B3, wherein the SDT feedback is based at least in part on whether an SDT reference signal received power exceeds a power threshold.

Embodiment B5. The method of Embodiment B4, wherein the SDT feedback includes a reference signal received power, RSRP.

Embodiment C1. A user equipment (UE) configured to communicate with a network node, the WD configured to, and/or comprising a radio interface and/or processing circuitry configured to:
compare a small data transmission, SDT, to an SDT parameter threshold; and
configure feedback to the network node, the feedback being based at least in part on successful and unsuccessful SDT procedures.

Embodiment C2. The UE of Embodiment C1, wherein the SDT feedback is based at least in part on whether an SDT volume exceeds a volume threshold.

Embodiment C3. The UE of Embodiment C2, wherein the SDT feedback includes a pending uplink data volume.

Embodiment C4. The UE of any of Embodiments C1-C3, wherein the SDT feedback is based at least in part on whether an SDT reference signal received power exceeds a power threshold.

Embodiment C5. The UE of Embodiment C4, wherein the SDT feedback includes a reference signal received power, RSRP.

Embodiment D1. A method implemented in a user equipment (UE), the method comprising:
comparing a small data transmission, SDT, to an SDT parameter threshold; and
configuring feedback to the network node, the feedback being based at least in part on successful and unsuccessful SDT procedures.

Embodiment D2. The method of Embodiment D1, wherein the SDT feedback is based at least in part on whether an SDT volume exceeds a volume threshold.

Embodiment D3. The method of Embodiment D2, wherein the SDT feedback includes a pending uplink data volume.

Embodiment D4. The method of any of Embodiments D1-D3, wherein the SDT feedback is based at least in part on whether an SDT reference signal received power exceeds a power threshold.

Embodiment D5. The method of Embodiment D4, wherein the SDT feedback includes a reference signal received power, RSRP.

### RA Report Enhancement

Rel-18 SON/MDT WID document (RP-221825) has identified enhancement to RA report to optimize and improve random access performance. In this paper, we discuss different aspects of the RA report, e.g., content and fetching mechanism in different scenarios.

### 2. Discussion

### 2.1 Enhancement of RA Report for DC Scenario

In this section enhancement of the RA reports collected when UE was configured with a dual connectivity (DC) operation is described. In DC operation and based on the current 3GPP TS 38.331, a UE logs RA report upon successful completion of the RA procedure toward MCG or SCG. In MR-DC, a UE logs the same set of RA related information and measurements, no matter if the RA was performed toward a cell in the SCG of in the MCG. Thus, a RAN node analyzing the RA reports would not be able to determine whether the reported RA information is associated to an RA performed toward a Cell in the MCG or in the SCG. The performance of an RA performed toward an MCG cell might be different from the performance of an RA procedure performed toward an SCG cell. For instance, an RA procedure may imply suffering poor coverage or too aggressive SN addition/SN change policy by neighbor cell for a node operating as SN in MR-DC. This this information is useful for network optimization.
Observation 1 Performance of the RA procedure for a cell in the MCG can be significantly different from the performance of RA procedure for the same cell being part of SCG. This is due to the fact that network policies for DC connectivity can be different from single connectivity.
Observation 2 When a RA report is received and analysed by a RAN node, the RAN node is not aware whether the RA procedure is performed toward a cell in the MCG or in the SCG.
Observation 3 By knowing whether the RA report is associated to a random-access procedure executed toward a cell belonging to SCG or MCG, the network can differentiate the RACH issues as well as coverage issues for a cell acting as MCG or as SCG.

In light of above discussion, RAN2 may include information in the RA report to assist the network differentiating between RA reports associated to a random-access procedure performed toward a cell acting as MN or as SN.
Proposal 1 Include information in the RA report on whether the random-access procedure was executed towards an MCG cell or an SCG cell.

### 2.2 Fetching NR RA Reports in EN-DC Scenario

In the RAN2 #121 meeting the following agreement is captured.

### Agreement:

1: To have “a list of SN RA report entries as a single NR container (i.e. NR RA-ReportList)”.

The mentioned agreement was part of discussion where RAN2 agreed that NR RA report should be sent to LTE node in EN-DC. However, reporting the NR RA report as part of LTE UE information Request/Response procedure requires some consideration on the request flag by the network. In our view, a dedicated NR RA report request flag is needed to be defined as part of LTE UE information Request procedure to enable only the LTE eNBs (capable of fetching NR RA report) to fetch the corresponding reports.
Observation 4 NR RA-Reports need to be fetched by the LTE eNB that are capable of fetching NR RA-Reports.
Proposal 2 Enhance the LTE UE information Request procedure with NR RA-Report request flag to fetch the NR RA-Report in LTE.

### 2.3 Optimization of RACH Partitioning Using RA Report

In 3GPP #119bis e-meeting, RAN2 agreed to discuss RACH report enhancements for RACH partitioning optimization as the following:

### Agreement:

Agree to add the following parameters into RACH report for RACH partitioning:
Feature or the combination of features that triggered the RACH.
Used feature combination.

In this section, enhancement of the RA reports collected when UE was configured with feature combination RACH resources is described.

A network might partition and isolate RA resources per feature, i.e., a preamble set is configured for a feature. The network that is interested in optimizing the RA parameter configurations, uses the RA report to identify any issues faced by a UE while performing the RA procedure.

However, a gNB may change the RACH partitions over time based on the load in different partitions. A UE logs the RA related information at the execution of RA procedure while the network may change the RA configuration dynamically over time. Therefore, the network may have different RACH resource configuration at the time the network fetches the logged information in RA report.
Observation 5 A gNB may reconfigure the RACH partitions based on the load over each partition.

Hence, a network can optimize its resources by having information of the concerned configuration of the used feature by the UE that triggered the RA procedure i.e., the set of preambles allocated to the RA partition such as the start preamble index and/or the number of preambles in the partition.
Observation 6 A network can optimize its RACH partitioning resources by having information of preambles allocated to the RA partition.

RA partitioning related information in RA report may be useful for the network in order to optimize the RA performance for each of the feature separately. For example, a gNB can reallocate the RA resources e.g., sub-set of preambles assigned to the group of the features based on the demands coming/initiated from the group of features. On the other side the group of the features bundled together can be shuffled and optimized to evenly distribute the load over different RA partitions.

In light of above, the following is proposed:
Proposal 3 UE include start preamble index and the number of preambles in the partition that triggered the RA procedure in the RA report.

Moreover, in the meeting RAN2 #120, RAN2 has agreed to include the NSAG ID in the RA report for the sake of RACH resource optimization when the applicable feature is slicing.

### Agreements:

1 For RACH report for RACH partitioning, RAN2 to agree to include NSAG ID when the applicable feature is slicing.

However, optimizing the RACH partitions allocated to different slice groups is dependent to how the slices are mapped to the slice groups. It is a quite plausible scenario that the demand for the specific slices might be different in the same group and hence RACH partitions allocated to some slice groups might become overloaded due to specific highly demanded slices. Distinguishing such highly demanded slices in various slice groups via RA-Report assists the network nodes and management system to evenly distribute the slices over different slice groups and eventually over different RACH partitions which accordingly leads to a more balanced RACH load over different RACH partitions. To address the impact of slice grouping in the RACH performance in each RA partition, we propose the UE includes the S-NSSAI (one or more S-NSSAI) beside the NSAG ID for which the RACH was triggered in the RACH report.
Observation 7 The slices information (S-NSSAI) beside the NSAG ID is essential to evenly distribute the RACH load between different RACH partitions based on the demands for specific slices.
Proposal 4 UE include slice information, i.e., S-NSSAI(s) that triggered the RACH through a given partition in the RA report.

### 2.2 RACH Report Logging in Case of SDT

In RAN2 #120 meeting it was agreed that UE includes RA and SDT information in the RA report if an SDT operation fails. However, there was no agreement on what information regarding SDT operation is to be provided by the UE.
Observation 8 Details of SDT information in RA report has not been yet discussed in RAN2.

An important aspect of the SDT configuration is the size of the threshold for the volume of data which is waiting to be transmitted and which may trigger the UE to use SDT (if the pending data volume is smaller than or equal to the threshold), i.e., the threshold referred to as sdt-Data VolumeThreshold in TS 38.331. Furthermore, in our understanding, failing in SDT operation refers that the UE attempted to use SDT (by checking the SDT RSRP threshold and SDT data volume threshold). A UE initiates

RACH procedure for SDT purpose if the pending data volume is smaller than or equal to the SDT data volume threshold sdt-Data VolumeThreshold. Hence, the UE will not include any information in the RA report for the times when the pending data volume was greater than the SDT data volume threshold, and consequently the network will not get any feedback information from those cases and would not be able to optimize SDT data volume threshold. Thus, we propose to include the amount of data above the SDT threshold in the RA report.
Proposal 5 UE reports the data volume at the time of attempting for SDT operation, if the data volume is less than a data volume reporting threshold, as part of the RA Report.

The data volume reporting threshold can be either configured by the network or can be defined based on the sdt-Data VolumeThreshold e.g., sdt-Data VolumeThreshold multiplied to 2 or 0.5. Therefore, the following is proposed.
Proposal 6 RAN2 discuss whether the data volume reporting threshold should be configurable or determined based on the sdt-Data Volume Threshold.

### 3 Conclusion

In the previous sections, the following observations were made:
Observation 1 Performance of the RA procedure for a cell in the MCG can be significantly different from the performance of RA procedure for the same cell being part of SCG. This is due to the fact that network policies for DC connectivity can be different from single connectivity.
Observation 2 When a RA report is received and analysed by a RAN node, the RAN node is not aware whether the RA procedure is performed toward a cell in the MCG or in the SCG.
Observation 3 By knowing whether the RA report is associated to a random-access procedure executed toward a cell belonging to SCG or MCG, the network can differentiate the RACH issues as well as coverage issues for a cell acting as MCG or as SCG.

The mentioned agreement was part of discussion where RAN2 agreed that NR RA report should be sent to LTE node in EN-DC. However, reporting the NR RA report as part of LTE UE information Request/Response procedure requires some consideration on the request flag by the network. In our view, a dedicated NR RA report request flag is needed to be defined as part of LTE UE information Request procedure to enable only the LTE eNBs (capable of fetching NR RA report) to fetch the corresponding reports.
Observation 4 NR RA-Reports need to be fetched by the LTE eNB that are capable of fetching NR RA-Reports.
Observation 5 A gNB may reconfigure the RACH partitions based on the load over each partition.
Observation 6 A network can optimize its RACH partitioning resources by having information of preambles allocated to the RA partition.
Observation 7 The slices information (S-NSSAI) beside the NSAG ID is essential to evenly distribute the RACH load between different RACH partitions based on the demands for specific slices. in RAN2.
Observation 8 Details of SDT information in RA report has not been yet discussed.

Based on the discussion in the previous sections, the following is proposed:
Proposal 1 Include information in the RA report on whether the random-access procedure was executed towards an MCG cell or an SCG cell.
Proposal 2 Enhance the LTE UE information Request procedure with NR RA-Report request flag to fetch the NR RA-Report in LTE.
Proposal 3 UE include start preamble index and the number of preambles in the partition that triggered the RA procedure in the RA report.
Proposal 4 UE include slice information, i.e., S-NSSAI(s) that triggered the RACH through a given partition in the RA report.
Proposal 5 UE reports the data volume at the time of attempting for SDT operation, if the data volume is less than a data volume reporting threshold, as part of the RA Report.
Proposal 6 RAN2 discuss whether the data volume reporting threshold should be configurable or determined based on the sdt-Data Volume Threshold.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| 3GPP | 3^{rd} Generation Partnership Project |
| 5G | 5^{th} Generation |
| 5GC | 5G Core network |
| 5GS | 5^{th} Generation System |
| AMF | Access and Mobility Management Function |
| ASN.1 | Abstract Syntax Notation One |
| CB | Contention-Based |
| CBRA | Contention-Based Random Access |
| CCA | Clear Channel Assessment |
| CE | Control Element |
| CFRA | Contention-Free Random Access |
| CG | Configured Grant |
| CGI | Cell Global Identity |
| CN | Core Network |
| CP | Control Plane |
| C-RNTI | Cell RNTI |
| CSI-RS | Channel State Information Reference Signal |
| CU | Central Unit |
| CU-CP | Central Unit Control Plane |
| CU-UP | Central Unit User Plane |
| DU | Distributed Unit |
| DC | Dual Connectivity |
| DL | Downlink |
| DMRS | Demodulation Reference Signal |
| DRB | Data Radio Bearer |
| DU | Distributed Unit |
| E1 | The interface between a CU-CP and a CU-UP. |
| E-CGI | E-UTRAN CGI |
| eNB | Evolved Node B/E-UTRAN Node B |
| en-gNB | A gNB acting as a secondary node in an EN-DC |
| | scenario (i.e., in a DC scenario with an Enb as the |
| | master node and a Gnb as the secondary node. |
| EPC | Evolved Packet Core |
| EPS | Evolved Packet System |
| E-UTRA | Evolved UTRA |
| E-UTRAN/ | Evolved UTRAN |
| EUTRAN | |
| F1 | The interface between a CU and a DU. |
| FDD | Frequency Division Duplex |
| FDM | Frequency Division Multiplexing |
| FR | Frequency Range |
| gNB | Radio base station in NR |
| HSS | Home Subscriber Server |
| HTTP | Hypertext Transfer Protocol |
| IAB | Integrated Access and Backhaul |
| ID | Identifier/Identity |
| IE | Information Element |
| I-RNTI | Inactive RNTI |
| LBT | Listen-Before-Talk |
| LTE | Long Term Evolution |
| MAC | Medium Access Control |
| MCC | Mobile Country Code |
| MCE | Measurement Collection Entity/Measurement |
| | Collector Entity |
| MDT | Minimization of Drive Tests |
| MME | Mobility Management Entity |
| MNC | Mobile Network Code |
| Msg | Message |
| NG | Next Generation |
| NG | The interface between an NG-RAN and a 5GC. |
| NGAP | NG Application Protocol |
| NG-RAN | NG Radio Access Network |
| NR | New Radio |
| NSAG | Network Slice Access stratum Group |
| NR-U | NR Unlicensed |
| O&M | Operation and Maintenance |
| OAM | Operation and Maintenance |
| PBCH | Physical Broadcast Channel |
| PCell | Primary Cell |
| PDCP | Packet Data Convergence Protocol |
| PDSCH | Physical Downlink Shared Channel |
| PDU | Protocol Data Unit |
| PLMN | Public Land Mobile Network |
| PO | PUSCH Occasion |
| PRACH | Physical Random Access Channel |
| PRU | PUSCH Resource Unit |
| PSCell | Primary Secondary Cell |
| PSS | Primary Synchronization Signal |
| PUSCH | Physical Uplink Shared Channel |
| RA | Random Access |
| RACH | Random Access Channel |
| RAN | Radio Access Network |
| RAR | Random Access Response |
| RAT | Radio Access Technology |
| RLC | Radio Link Control |
| RLF | Radio Link Failure |
| RNC | Radio Network Controller |
| RNL | Radio Network Layer |
| RNTI | Radio Network Temporary Identity |
| RO | RACH Occasion |
| RRC | Radio Resource Control |
| RSRP | Reference Signal Received Power |
| RSRQ | Reference Signal Received Quality |
| S1 | The interface between the RAN and the CN in LTE. |
| S1AP | S1 Application Protocol |
| Scell | Secondary Cell |
| SDT | Small Data Transmission |
| SFN | System Frame Number |
| SI | System Information |
| SIB | System Information Block |
| SON | Self-Organizing Network |
| S-NSSAI | Single Network Slice Selection Assistance |
| | Information |
| SRB | Signaling Radio Bearer |
| SS | Synchronization Signal |
| SSB | Synchronization Signal Block (also referred |
| | to as SS/PBCH Block) |
| SSS | Secondary Synchronization Signal |
| SUL | Supplementary Uplink |
| TA | Timing Advance |
| TA | Tracking Area |
| TCE | Trace Collection Entity/Trace Collector Entity |
| TDD | Time Division Duplex |
| TNGF | Trusted Non-3GPP Gateway Function |
| TNL | Transport Network Layer |
| TS | Technical Specification |
| TWIF | Trusted WLAN Interworking Function |
| UDM | Unified Data Management |
| UE | User Equipment |
| UL | Uplink |
| UMTS | Universal Mobile Telecommunication System |
| UPF | User Plane Function |
| URI | Uniform Resource Identifier |
| URL | Uniform Resource Locator Uniform Resource |
| | Locator |
| UTRA | Universal Terrestrial Radio Access |
| UTRAN | Universal Terrestrial Radio Access Network |
| WLAN | Wireless Local Area Network |
| X2 | The interface between two eNBs in LTE. |
| X2AP | X2 Application Protocol |
| Xn | The interface between two gNBs in NR. |
| XnAP | Xn Application Protocol |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a network node configured to communicate with a user equipment, UE, the method comprising:
receiving small data transmission, SDT, feedback information from the UE, the SDT feedback information being based at least in part on a volume of data, V, pending for uplink, UL, transmission and an SDT data volume threshold; and
performing one or more actions based at least in part on the SDT feedback information.

2. The method of claim 1, wherein the volume of data, V, represents an amount of UL data awaiting transmission across one or more radio bearers for which SDT is enabled in the UE.

3. The method of claim 1, wherein one or both of:
if the volume of data, V, is equal to or less than the SDT data volume threshold plus a first offset parameter, D, the SDT feedback information includes one or both of:
information associated with the volume of data pending for UL transmission; and
a first indication indicating that the volume of data, V, pending for UL transmission is equal to or less than the SDT data volume threshold plus the first offset parameter, D; and
the SDT feedback information includes the first indication indicating that a difference between the size of the volume of data pending for UL transmission and the SDT data volume threshold is a percentage of the SDT data volume threshold.

4.-7. (canceled)

8. The method of claim 1, wherein the SDT feedback information includes a fourth indication indicating:
the volume of data, V, and a first relation to the SDT data volume threshold; and
a measured RSRP, and a second relation to an RSRP threshold.

9. The method of claim 1, wherein the SDT feedback information is comprised in a random access report.

10. The method of claim 1, wherein the SDT feedback information is received from the UE according to one or more of:
per each random access procedure;
in a random access portion of:
a radio link failure report; or
a connection establishment failure report;
in an information element associated with a random access information parameter; and
per random access attempt.

11. The method of claim 1, wherein the one or more actions includes:
adjusting SDT data volume threshold based at least in part on the SDT feedback information;
determining an SDT configuration; and
transmitting the SDT configuration to the UE.

12. A network node configured to communicate with a user equipment, UE, the network node being configured to:
receive small data transmission, SDT, feedback information from the UE, the SDT feedback information being based at least in part on a volume of data, V, pending for uplink, UL, transmission and an SDT data volume threshold; and
perform one or more actions based at least in part on the SDT feedback information.

13.-22. (canceled)

23. A method in a user equipment, UE, configured to communicate with a network node, the method comprising:
determining small data transmission, SDT, feedback information, the SDT feedback information being based at least in part on a volume of data, V, pending for uplink, UL, transmission and an SDT data volume threshold; and
transmitting the SDT feedback information to the network node.

24. The method of claim 23, wherein the volume of data, V, represents an amount of UL data awaiting transmission across one or more radio bearers for which SDT is enabled in the UE.

25. The method of claim 23, wherein one or both of:
if the volume of data, V, is equal to or less than the SDT data volume threshold plus a first offset parameter, D, the SDT feedback information includes one or both of:
information associated with the volume of data pending for UL transmission; and
a first indication indicating that the volume of data, V, pending for UL transmission is equal to or less than the SDT data volume threshold plus the first offset parameter, D; and
the SDT feedback information includes the first indication indicating that a difference between the size of the volume of data pending for UL transmission and the SDT data volume threshold is a percentage of the SDT data volume threshold.

26. The method of claim 25, wherein the first offset parameter, D, is based on the SDT data volume threshold.

27. The method of claim 25, wherein one or both of:
the SDT data volume threshold is associated with a reference signal received power, RSRP, threshold; and
if the UE supports SDT, a measured RSRP is above the RSRP threshold, and SDT is not used, the SDT feedback information includes a second indication indicating whether the volume of data, V, is greater than the SDT data volume threshold plus the first offset parameter, D.

28. The method of claim 23, wherein if the volume of data, V, is greater than or equal to the SDT data volume threshold minus a second offset parameter, D_{low}, and the volume of data, V, is less than or equal to the SDT data volume threshold plus a third offset parameter, D_{high}, one or both of:
the SDT feedback information includes information associated with the volume of data pending for UL transmission; and
a third indication indicating that the volume of data, V, is greater than or equal to the SDT data volume threshold minus the second offset parameter, D_{low}, and the volume of data, V, is less than or equal to the SDT data volume threshold plus the third offset parameter, D_{high}, the third offset parameter, D_{high}, being greater than the second offset parameter, D_{low}.

29. The method of claim 23, wherein the SDT feedback information includes a parameter describing a cause for not using SDT.

30. The method of claim 23, wherein the SDT feedback information includes a fourth indication indicating:
the volume of data, V, and a first relation to the SDT data volume threshold; and
a measured RSRP, and a second relation to an RSRP threshold.

31. The method of claim 23, wherein the SDT feedback information is comprised in a random access report.

32. The method of claim 23, wherein the SDT feedback information is transmitted from the UE according to one or more of:
per each random access procedure;
in a random access portion of:
a radio link failure report; or
a connection establishment failure report;
in an information element associated with a random access information parameter; and
per random access attempt.

33. The method of claim 23, wherein one or both of:
transmitting the SDT feedback information to the network node triggers the network node to one or both of:
adjust SDT data volume threshold based at least in part on the SDT feedback information; and
determine an SDT configuration; and
the method further includes receiving the SDT configuration from the network node.

34. A user equipment, UE, configured to communicate with a network node, the UE being configured to:
determine small data transmission, SDT, feedback information, the SDT feedback information being based at least in part on a volume of data, V, pending for uplink, UL, transmission and an SDT data volume threshold; and
transmit the SDT feedback information to the network node.

35.-44. (canceled)
